(19) United States
(12) Patent Application Publication
(10) Pub. No.: US 2009/0034760 A1
(43) Pub. Date: Feb. 5, 2009

(54) ELECTRONIC COMPONENT, FABRICATION METHOD FOR THE SAME AND ELECTRONIC DEVICE HAVING THE SAME

(76) Inventors: Masanori MINAMIO, Osaka (JP); Yoshihiro Tomita, Osaka (JP); Toshiyuki Fukuda, Kyoto (JP)

Correspondence Address: MCDERMOTT WILL & EMERY LLP, 600 13TH STREET, NW, WASHINGTON, DC, 20005-3096, US

(21) Appl. No.: 12/180,875

(22) Filed: Jul. 28, 2008

(30) Foreign Application Priority Data
Aug. 3, 2007 (JP) 2007-203085

(51) Int. Cl. H04R 1/00

(52) U.S. Cl. 381/175; 381/369

(57) ABSTRACT

The electronic component includes: a fixed film; a vibration film facing the fixed film; a first electrode formed on the fixed film and having at least one first through hole in the center portion; and a second electrode formed on a portion of the vibration film corresponding to the first electrode and having at least one second through hole in the peripheral portion. An air gap communicating with the first and second through holes is formed between the fixed film and the vibration film and surrounded with a rib. At least one side hole is provided to extend in the rib surrounding the air gap from the air gap toward outside.

### CROSS-REFERENCE TO RELATED APPLICATIONS

This application claims priority under 35 U.S.C. §119 on Patent Application No. 2007-203085 filed in Japan on Aug. 3, 2007, the entire contents of which are hereby incorporated by reference.

### BACKGROUND OF THE INVENTION

1. Field of the Invention

The present invention relates to an electronic component using micro-electro-mechanical system (MEMS) technology, a fabrication method for the same and an electronic device using the same.

2. Background of the Invention

Along with the progress in smaller and thinner electronic equipment, development of electronic components and electronic devices using the MEMS technology is underway. Examples of such electronic devices include a sensor switch and an electret condenser microphone (ECM). One of the components of the ECM is an electret condenser.

Conventional sensor switches and electret condensers had a shape of a diaphragm in which a vibration film made of a flexible organic film such as polyimide is bonded to a base made of resin, ceramic and the like. In recent years, microfabrication technology for fabrication of semiconductor devices has been increasingly adopted for formation of a base of a diaphragm, a vibration film on the base and a fixed film (back-plate film) as an electret film, formation of an air gap between the vibration film and the fixed film and the like.

As a result of adoption of microfabrication technology, the air gap has become narrow. This has caused the following problem. When a sensor switch or an ECM is used in hot and humid surroundings, moisture in the air gap may be condensed. Due to this condensation, the vibration film and the fixed film come to stick to each other.

In the conventional structure, through holes (first and second through holes) are formed in the fixed film (electret film) and the vibration film, respectively. Water vapor or moisture taken in into the air gap via such holes must be swiftly discharged to avoid the disadvantage that part of such water vapor or moisture may be left behind and condensed.

To address the above problem, disclosed is formation of a hydrophobic layer on either or both of the inner surface of the fixed film and the inner surface of the vibration film of the diaphragm (see Japanese National Phase PCT Laid-Open Patent Publication No. 2005-508579 (Patent Document 1), for example). According to this technique, a hydrophobic layer is formed on either or both of the inner surface of the fixed film and the inner surface of the diaphragm vibration film by allowing a hydrophobic material such as liquid-phase perfluoroalkylsilane, for example, to flow into the air gap via the first and second through holes of the fixed film and the diaphragm vibration film. With such a hydrophobic film, sticking between the vibration film and the fixed film is prevented, and thus the performance of the electret condenser is prevented from being adversely affected.

Due to condensation, also, the surface resistance may be broken in the insulating section between the fixed film and the diaphragm vibration film in the air gap, rendering the ECM unusable or causing local electrical conduction resulting in noise increase in the ECM.

To avoid such inability of use and occurrence of noise in the ECM, it is necessary to prevent condensation in the insulating section in the air gap or prevent formation of an insulating section rendered conductive.

To address the above problem, disclosed is a configuration in which the fixed film (electret film) or the vibration film is reduced to one-third in volume heat capacity and to one-hundredth in heat conductivity compared with the housing of the ECM (see Japanese Laid-Open Patent Publication No. 05-7397 (Patent Document 2), for example). This document argues that the ECM using an element having such properties can both suppress condensation in the insulating section in the air gap and prevent the insulating section from becoming locally conductive.

### SUMMARY OF THE INVENTION

However, the techniques disclosed in Patent Documents 1 and 2 described above have their respective problems as follows.

In the technique of Patent Document 1, sticking between the vibration film and the fixed film (electret film) is prevented with formation of a hydrophobic layer. However, waterdrops and dewdrops adhering to the hydrophobic layer have the nature of reducing the surface area because the attractive forces between water molecules act toward the center. As a result, waterdrops and dewdrops formed from water vapor and moisture entering the air gap are slow in evaporation speed, and this tends to degrade the insulation property of the fixed film and vibration film. This problem therefore must be solved.

In the technique of Patent Document 2, formation of waterdrops and dewdrops in the air gap is prevented by adopting the configuration in which the fixed film and the diaphragm vibration film are made smaller in volume heat capacity and heat conductivity than the housing. However, these conditions to be satisfied significantly narrow the choice of materials for the fixed film, the vibration film and the housing, and this makes it difficult to implement a sensor switch and an ECM. This problem therefore must be solved.

In view of the above, an object of the present invention is, while solving the above problems, preventing sticking between the vibration film and the fixed film (electret film) due to waterdrops, dewdrops and the like entering the air gap and also preventing decrease in surface resistance in the insulating section between the two films.

Specifically, the electronic component of the present invention includes: a fixed film; a vibration film facing the fixed film; a first electrode provided on the fixed film, the first electrode having at least one first through hole; a second electrode provided on a portion of the vibration film corresponding to the first electrode; an air gap provided between the fixed film and the vibration film and surrounded with a rib, the air gap communicating with the first through hole and the second through hole; and at least one side hole provided in the rib surrounding the air gap, the side hole communicating with the air gap. The fixed film is an electret film.

According to the electronic component of the present invention, even if water vapor or moisture enters the air gap when the component is used in hot and humid surroundings, this trouble can be solved with the side hole (hole acting as a capillary) provided in the sidewall (rib) surrounding the air gap. That is, moisture in the air gap can be trapped (absorbed) into the side hole. Moreover, in the case of the side hole extending through the rib to outside, moisture can be discharged outside and also dry air can be taken in from outside via the reverse route. Dewdrops that may be formed in the air gap can also be trapped into or discharged via the side hole in the same manner. Hence, the electronic component is prevented from the trouble of becoming unusable, which otherwise occurs because the fixed film and the vibration film facing with narrow space therebetween to form the air gap stick to each other due to moisture, and also prevented from decrease in surface resistance due to moisture in the insulating section and resultant occurrence of a noise source.

Also, with no special limitation on the materials of the elements, the freedom in choice of materials will not be reduced.

Preferably, the first through hole is provided in the center portion of the first electrode, and the second through hole is provided in the peripheral portion of the second electrode. The first through hole and the second through hole may be placed in this manner.

Preferably, the at least one side hole extends through the rib.

With such a side hole extending through the rib, the air gap is allowed to communicate with the outside of the electronic component via the side hole. As a result, moisture can be discharged outside from the air gap, and this further ensures prevention of sticking between the fixed film and the vibration film and prevention of decrease in surface resistance in the insulating section.

Preferably, the at least one side hole has a curved shape.

Having a curved shape, the side hole can be made longer, and this imparts the ability of trapping moisture to the side hole.

Preferably, the thickness of the at least one side hole is the same as the thickness of the air gap. The thickness of the side hole refers to the size of the side hole along the thickness of the air gap. Such a side hole can be easily formed.

Preferably, the electronic component further includes a base made of a substrate having an opening, wherein a first bonding metal film provided on a portion of the vibration film and a second bonding metal film provided on the base are connected to each other.

By adopting the above configuration, an electronic component having an electret condenser part on a base can be fabricated by first forming the base and the electret condenser part individually and then bonding the two parts together. As a result, if a defect occurs in either one of the base and the electret condenser part, the defective one can be replaced with new one to present the component as conforming one. Hence, the fabrication yield as the component can be improved, and resultantly the fabrication cost can be reduced.

As the electronic component, a sensor switch or an electret condenser microphone can be assumed. The present invention will exert a significant effect when being applied to these electronic components.

The fabrication method for an electronic component of the present invention includes the steps of: forming a multilayer structure including a structure having a sacrifice film sandwiched between a fixed film and a vibration film and surrounded with a rib; and forming an air gap sandwiched between the fixed film and the vibration film and surrounded with the rib by removing the sacrifice film from the multilayer structure, wherein in the step of forming a multilayer structure, part of the sacrifice film is made to extend in the rib, and in the step of forming an air gap, at least one side hole extending in the rib from the air gap is provided in addition to the air gap.

According to the fabrication method for an electronic component of the present invention, the inventive electronic component described above having at least one side hole extending in the rib and communicating with the air gap can be fabricated.

Preferably, the step of forming a multilayer structure includes the steps of: (a) forming a vibration film having at least one vibration film through hole on a semiconductor substrate; (b) forming a sacrifice film on the vibration film, the sacrifice film having a rib formation groove surrounding a region in which the vibration film through hole is formed and having a depth reaching the vibration film; (c) forming a fixed film having at least one fixed film through hole on the sacrifice film and also forming a rib in the rib formation groove; (d) forming a first electrode made of a conductive film on a portion of the fixed film excluding the fixed film through hole and its surroundings and then forming a surface protection film covering the first electrode; and (e) after the step (d), forming a base by forming an opening in the center portion of the semiconductor substrate to reach the back surface of the vibration film, after the step (e), the step of forming an air gap is performed, after the step of forming an air gap, the fabrication method further comprises the step of forming a second electrode made of a conductive film at least on the surface of the vibration film facing the base, and in the step (b), the sacrifice film is formed so that part of the sacrifice film surrounded with the rib formation groove extends in the rib formation groove, and thus in the step (c), part of the sacrifice film surrounded with the rib extends in the rib.

The above method may be adopted as a more specific fabrication method for an electronic component of the present invention.

Preferably, the step of forming a multilayer structure includes the steps of: (f) forming a surface protection film on one surface of a first semiconductor substrate and then forming a first electrode made of a conductive film on the surface protection film: (g) forming a fixed film having at least one fixed film through hole on the surface protection film so as to cover the first electrode; (h) forming a sacrifice film on the fixed film, the sacrifice film having a rib formation groove surrounding a region in which the fixed film through hole is formed and having a depth reaching the fixed film; (i) forming a vibration film having at least one vibration film through hole on the sacrifice film and also forming a rib in the rib formation groove; (j) forming a first bonding metal film on a portion of the vibration film located above the rib; (k) forming an oxide film on a second semiconductor substrate different from the first semiconductor substrate, and then forming a second bonding metal film on the oxide film so as to correspond to the first bonding metal film; (l) aligning the first bonding metal film and the second bonding metal film with each other to face each other and alloying the bonding metal films with each other, to bond the first semiconductor substrate and the second semiconductor substrate to each other; and (m) forming a base by forming an opening in the center portion of the second semiconductor substrate, after the step (m), the step of forming an air gap is performed, after the step of forming an air gap, the fabrication method further comprises the step of forming a second electrode made of a conductive film at least on the surface of the vibration film facing the base, and in the step (h), the sacrifice film is formed so that part of the sacrifice film surrounded with the rib formation groove extends in the rib formation groove, and thus in the step (i), part of the sacrifice film surrounded with the rib extends in the rib.

The above method may otherwise be adopted as a more specific fabrication method for an electronic component of the present invention. In particular, in this fabrication method, the base and the electret condenser part to be placed on the base can be formed individually and then bonded together to present the inventive electronic component. Hence, as already described earlier, the fabrication yield improves and this leads to reduction in fabrication cost.

Preferably, the second electrode is formed on the sidewall of the opening of the base and the bottom surface of the base, in addition to the surface of the vibration film facing the base. The second electrode may also be formed on such places.

Preferably, the step of forming an air gap is performed using wet etching, and an etchant used in the wet etching is heated to reduce the viscosity.

By reducing the viscosity of the etchant as described above, microfabrication can be facilitated, and thus formation of the side hole functioning as a capillary can be facilitated.

Preferably, ultrasonic vibration is applied to the etchant. This further facilitates microfabrication.

The electronic device of the present invention includes: any one of the inventive electronic components described above; at least one semiconductor element; at least one passive electronic component; a printed board having two mount regions, the electronic component, the semiconductor element and the passive electronic component being mounted on one of the mount region while external connection terminals being provided on the other mount region; metal fine wires for connecting electrode terminals of the electronic component with electrode terminals of the printed board and electrode terminals of the semiconductor element; and a shield case attached to the printed board to cover the electronic component, the semiconductor element, the passive electronic component and metal fine wires.

With the above configuration, an electronic device using the inventive electronic component can be implemented.

As described above, the inventive electronic component and the electronic device using the same can trap (absorb) or discharge water vapor and moisture entering the air gap, and moreover take in external dry air, by means of the side hole as a capillary, even in use in hot and humid surroundings. Hence, a small, trouble-free electronic component and an electronic device using such a component can be implemented.

### BRIEF DESCRIPTION OF THE DRAWINGS

FIG. 1A is a plan view of an electret condenser 1 of Embodiment 1 of the present invention, FIG. 1B is a cross-sectional view taken along line Ib-Ib′ in FIG. 1A, and FIG. 1C is a cross-sectional view taken along line Ic-Ic′ in FIG. 1A.

FIGS. 2A and 2B are respectively a plan view and a cross-sectional view taken along line IIb-IIb′ in FIG. 2A, showing a state in a fabrication method for the electret condenser 1 in which silicon oxide films 19 are formed on both surfaces of a semiconductor substrate 20 and silicon nitride films 16a are formed on the silicon oxide films 19.

FIGS. 3A and 3B are respectively a plan view and a cross-sectional view taken along line IIIb-IIIb′ in FIG. 3A, in which second through holes 17 are formed through one of the silicon nitride films 16a.

FIGS. 4A and 4B are respectively a plan view and a cross-sectional view taken along line IVb-IVb′ in FIG. 4A, in which a sacrifice film 12 is formed over the silicon nitride film 16a having the second through holes 17 and a rib formation groove 13 is formed through the sacrifice film 12.

FIGS. 5A and 5B are respectively a plan view and a cross-sectional view taken along line Vb-Vb′ in FIG. 5A, in which the other silicon nitride film 16a on the semiconductor substrate 20 is removed.

FIGS. 6A and 6B are respectively a plan view and a cross-sectional view taken along line VIb-VIb′ in FIG. 6A, in which a multilayer film composed of a lower insulating film 9, a fixed film 8 and an upper insulating film 7 is formed on the sacrifice film 12.

FIGS. 7A and 7B are respectively a plan view and a cross-sectional view taken along line VIIb-VIIb′ in FIG. 7A, in which first through holes 11 are formed through the multilayer film.

FIGS. 8A and 8B are respectively a plan view and a cross-sectional view taken along line VIIIb-VIIIb′ in FIG. 8A, in which a conductive film 42 is formed on the upper insulating film 7.

FIGS. 9A and 9B are respectively a plan view and a cross-sectional view taken along line IVb-IVb′ in FIG. 9A, in which part of the conductive film 42 is removed to form a first electrode 6.

FIGS. 10A and 10B are respectively a plan view and a cross-sectional view taken along line Xb-Xb′ in FIG. 10A, in which a surface protection film 4 is formed on the first electrode 6 and the exposed portion of the upper insulating film 7.

FIGS. 11A and 11B are respectively a plan view and a cross-sectional view taken along line XIb-XIb′ in FIG. 11A, in which a base opening 22 is formed through the semiconductor substrate 20 from its bottom surface and thereafter the silicon oxide film 19 on the back surface of a vibration film 16 is removed, to form a base 21.

FIGS. 12A and 12B are respectively a plan view and a cross-sectional view taken along line XIIb-XIIb′ in FIG. 12A, in which electrode terminal openings 5 and the first through holes 11 are formed through the surface protection film 4, and thereafter an air gap 14 and side holes 15 are formed.

FIGS. 13A and 13B are respectively a plan view and a cross-sectional view taken along line XIIIb-XIIIb′ in FIG. 13A, in which the resultant substrate is left to stand in the discharging environment to charge the fixed film 8, and thereafter a second electrode 18 is formed.

FIG. 14A is a plan view of an electret condenser 2 of Embodiment 2 of the present invention, FIG. 14B is a cross-sectional view taken along line XIVb-XIVb′ in FIG. 14A, and FIG. 14C is an enlarged cross-sectional view taken along line XIVc-XIVc′ in FIG. 14A.

FIG. 15A is a cross-sectional view in which a replica 41 is formed on one surface of a first semiconductor substrate 23. FIG. 15B is a cross-sectional view in which a surface protection film 4 is formed covering the replica 41. FIG. 15C is a cross-sectional view in which a pattern of a first electrode 6 made of a conductor is formed on the surface protection film 4. FIG. 15D is a cross-sectional view in which a 3-layer film composed of an upper insulating film 7, a fixed film 8 and a lower insulating film 9 is formed on the first electrode 6.

FIG. 16A is a cross-sectional view in which a sacrifice film 12 having a rib formation groove 13 is formed on the lower insulating film 9. FIG. 16B is a cross-sectional view in which a vibration film 12 having second through holes 17 is formed on the sacrifice film 12. FIG. 16C is a cross-sectional view in which a pattern of a first bond metal film 24 made of a silicon film is formed on the vibration film 16.

FIG. 17A is a cross-sectional view in which silicon oxide films 19 are formed on both surfaces of a second semiconductor substrate 25. FIG. 17B is a cross-sectional view in which a second bonding metal film 26 made of a gold film is formed on one of the silicon oxide films 19.

FIG. 18A is a cross-sectional view in which the multilayer structure including the first semiconductor substrate 23 and the multilayer structure including the second semiconductor substrate 25 are bonded together. FIG. 18B is a cross-section view in which a base opening 22 is formed through the second semiconductor substrate 25 and the first semiconductor substrate 23 is removed. FIG. 18C is a cross-sectional view in which a mask pattern on the back surface of the second semiconductor substrate 25 and the silicon oxide film 18 on the top surface thereof are removed. FIG. 18D is a cross-sectional view in which center through holes in the first through holes 11 and electrode terminal openings 5 are formed through the surface protection film 4, and an air gap 14 and side holes 15 are formed by removing the sacrifice film 12. FIG. 18E is a cross-sectional view in which the resultant structure is left to stand in the discharging environment to charge the fixed film, and a second electrode 18 is formed on the back surface of the vibration film 16, the sidewall of the base opening 22 and the back surface of the base.

FIG. 19A is a plan view of an electret condenser 1c of Embodiment 3 of the present invention having side holes 15 that are not open to outside, FIG. 19B is a cross-sectional view taken along line XIXb-XIXb′ in FIG. 19A, and FIG. 19C is a plan view of an alteration having the side holes 15 that are not open to outside.

FIG. 20A is a plan view of an ECM provided with a shield case of Embodiment 4 of the present invention, showing the state without the shield case, and FIG. 20B is a cross-sectional view taken along line XXb-XXb′.

### DESCRIPTION OF THE PREFERRED EMBODIMENTS

Hereinafter, preferred embodiments of the present invention will be described with reference to the accompanying drawings. It should be noted that although the present invention will herein be described taking an electret condenser as an example of the electronic component using the MEMS technology and an ECM as an example of the electronic device, the electronic component and the electronic device according to the present invention are not limited to these. Other examples include a sensor switch and the like. The present invention is thus widely applicable to various electronic components and electronic devices using such electronic components. Note also that the drawings referred to are all diagrammatical sketches and are not necessarily the same as the actual ones in scale and the number of pieces of some components.

### Embodiment 1

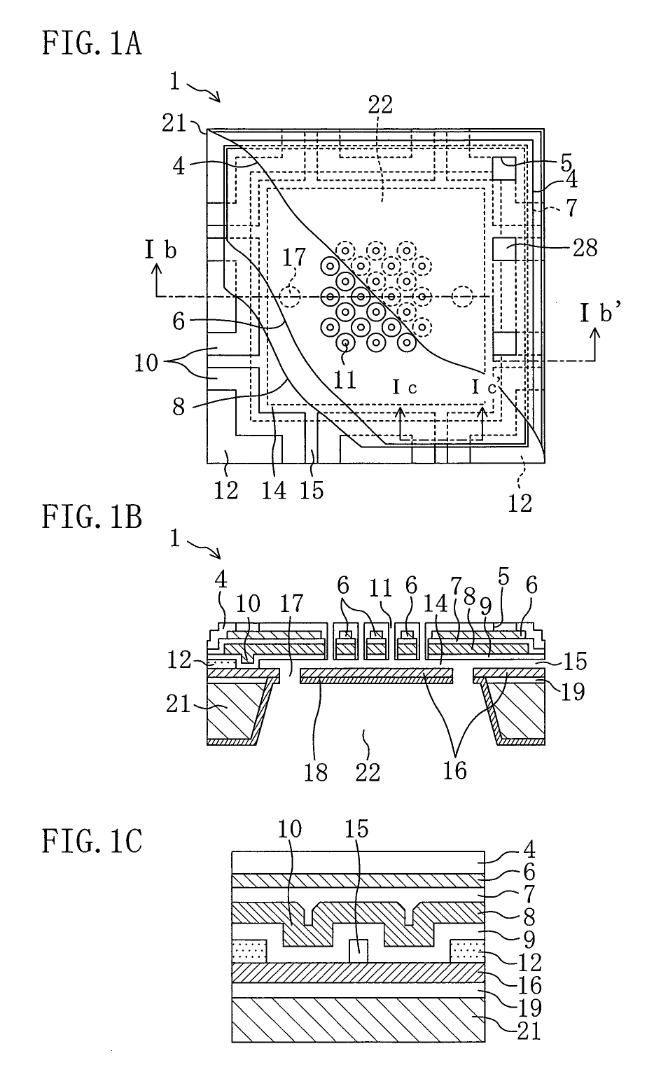

An electronic component of Embodiment 1 and a fabrication method for the same will be described. FIGS. 1A to 1C show a structure of an electret condenser 1 as an electronic component, in which FIG. 1A is a plan view with elements partly being cut away, FIG. 1B is a cross-sectional view taken along line Ib-Ib′ in FIG. 1A, and FIG. 1C is a cross-sectional view taken along line Ic-Ic′ in FIG. 1A.

As shown in FIGS. 1A to 1C, the electret condenser 1 of this embodiment is formed using a base 21 that has a base opening 22 of a predetermined size formed in the center portion of a silicon substrate.

A vibration film 16 is formed on the base 21 covering the base opening 22, to constitute a diaphragm together with the base 21. A fixed film 8 as an electret film is placed to face the vibration film 16 with an air gap 14 therebetween. The air gap 14 is surrounded with a rib 10 that can be regarded as a sidewall. The rib 10 is formed as a portion of the fixed film 8 protruding toward the base 21 in the illustrated example. The fixed film 8 is vertically sandwiched between a lower insulating film 9 and an upper insulating film 7.

A first electrode 6 is provided on the upper insulating film 7 covering the fixed film 8, and a surface protection film 4 is provided to cover the first electrode 6. A second electrode 18 is provided to cover the bottom surface (facing the base opening 22) of the vibration film 16, the sidewall of the base opening 22 and the bottom surface of the base 21 (opposite to the surface facing the vibration film 16).

One or more (plural in this embodiment) first through holes 11 are provided in the center region of the multilayer film including the fixed film 8 located above the air gap 14, to reach the air gap 14 through the multilayer film. Also, one or more second through holes 17 for condensation prevention are provided in the peripheral portion of the base opening 22 to reach the air gap 14 through the vibration film 16 and the underlying second electrode 18.

The rib 10 is divided into a plurality of rib portions, and between the rib portions, side holes 15 as narrow holes (capillaries) extend along the top surface of the base 21.

The side holes 15, which are fine holes extending toward outside in the rib 10 as the sidewall surrounding the air gap 14. When the side holes 15 do not extend through the rib 10, they serve to trap (soak) water vapor therein from the air gap 14. When the side holes 15 extend through the rib 10 to outside (as illustrated in this embodiment), they serve both to discharge water vapor from the air gap 14 outside and take in dry air into the air gap 14 from outside.

Once the electret condenser 1 is mounted on a module substrate (not shown), the base opening 22 is blocked from the bottom and sealed. In this case, therefore, air flowing into the air gap 14 via the first through holes 11 may reach the base opening 22 via the second through holes 17 formed through the vibration film 16 and the like, but will never flow outside.

In the conventional electret condenser 1 provided with no such a contrivance as the side holes 15, there is no route allowing the air to flow outside except for the equivalent of the first through holes 11. In the electret condenser 1 of this embodiment, however, which is provided with the side holes 15, air having flowed in via the first through holes 11 can flow outside via the side holes 15. Condensation in the air gap 14 can therefore be suppressed. If condensation occurs, also, water can be discharged outside via the side holes 15.

Hence, the fixed film 8 and the vibration film 16 facing each other with the narrow air gap 14 therebetween can be suppressed from sticking to each other due to moisture, and thus the component is prevented from becoming unusable due to this sticking. Also, the surface resistance is suppressed from decreasing due to moisture in the insulating section between the fixed film 8 and the vibration film 16, and thus the occurrence of the component becoming unusable and noise increase due to this decrease in surface resistance can be suppressed.

As described above, with the presence of the side holes 15 that can suppress condensation and discharge moisture, the electret condenser 1 of this embodiment is excellent in moisture resistance, reliability and performance.

Next, the individual elements of the electret condenser 1 of this embodiment, in particular, the base 21, the vibration film 16, the fixed film 8, the air gap 14, the side holes 15 and electrode terminals 28 will be described in more detail.

The base 21 whose plan shape is a circle or a polygon including a rectangle (a square in this embodiment as an example) is provided with the base opening 22 in its center portion. The base opening 22 is divergent from the top toward the bottom (from the side facing the vibration film 16 toward the opposite side), in which the sidewall is tilted in vertical section (see FIG. 1B). Although the base opening 22 is rectangular in plan shape, the shape is not limited to this.

The base 21 is formed of the silicon semiconductor substrate in this embodiment, but the material is not limited to this. For example, a semiconductor made of germanium, gallium arsenide, silicon carbide and the like, ceramic made of aluminum oxide, aluminum nitride and the like, and glass such as Pyrex, Terex and quartz may be used.

The vibration film 16 is formed on one surface of the base 21 via a silicon oxide film 19 and covers the base opening 22. One or more second through holes 17 are provided in the periphery of the portion of the vibration film 16 located above the base opening 22. The base 21 and the vibration film 16 constitute a diaphragm of the electret condenser 1.

The vibration film 16 is formed of a silicon nitride film in this embodiment, but the material is not limited to this. For example, an insulating film of polycrystalline silicon, aluminum oxide, aluminum nitride and the like may be used.

The second electrode 18 is formed on the surface of the vibration film 16 exposed to the base opening 22, the tilted sidewall of the base opening 22 of the base 21 and the back surface of the base 21. The conductive film constituting the second electrode 18 is a gold (Au) film in this embodiment, but the material is not limited to this. For example, the material may be any one of copper, nickel, an aluminum alloy and the like, or may be a multilayer structure of such conductive films.

The fixed film 8 is sandwiched between the upper insulating film 7 and the lower insulating film 9 forming a 3-layer structure. The first electrode 6 made of a conductive film is provided on the upper insulating film 7. The end faces of the outer sides of the fixed film 8 are all located inside with respect to the end faces of the upper and lower insulating films 7 and 9. Hence, the end faces of the fixed film 8 are covered with the upper insulating film 7.

One or more first through holes 11 are formed in the center portion of the fixed film 8. The first through holes 11 extend through the upper and lower insulating films 7 and 9 in addition to the fixed film 8, to communicate with the air gap 14. The first through holes 11 can be in the shape of a circle, a rectangle or the like, and the size thereof (the diameter of the circle, the length of a side of the rectangle or the like) is preferably 3 μm to 50 μm, more preferably 5 μm to 8 μm.

At a position corresponding to each of the first through holes 11 of the fixed film 8, a hole larger in diameter than the first through hole 11 is provided through the first electrode 6 placed on the upper insulating film 7. The surface protection film 4 is provided to cover the first electrode 6. The surface protection film 4 also covers the portions of the upper insulating film 7 uncovered with the first electrode 6 and the side faces of the fixed film 8, the upper insulating film 7 and the lower insulating film 9 exposed inside the through holes 11.

The fixed film 8 is formed of a silicon oxide film, but is not limited to this. For example, silicon nitride, polycrystalline silicon and the like may be used. As the material of the upper insulating film 7 and the lower insulating film 9, a dielectric film of silicon nitride, polycrystalline silicon, aluminum oxide, aluminum nitride and the like may be used. As the material of the first electrode 6, a conductive film such as an aluminum alloy, gold, copper, a multilayer member of aluminum and nickel, a multilayer member of cooper and nickel and the like may be used. As the material of the surface protection film 4, a silicon nitride film, a silicon oxide film and the like may be used.

The air gap 14 is the space sandwiched between the vibration film 16 and the fixed film 8 and surrounded with the rib 10. The thickness thereof (the distance between the vibration film 16 and the fixed film 8), which is determined with the height of the rib 10 as a protrusion of the fixed film 8 toward the base 21, is preferably in the range of 0.3 μm to 10 μm, more preferably in the range of 0.5 μm to 5 μm. The air gap 14 is made to communicate with the base opening 22 via the second through holes 17 provided through the vibration film 16, and also made to communicate with outside via the side holes 15 extending through the rib 10 to outside and the first through holes 11 provided through the fixed film 8.

The rib 10 is formed as a protrusion of the fixed film 8 and the lower insulating film 9 toward the vibration film 16 to join the vibration film 16, in the region of the surface of the fixed film 8 facing the vibration film 16 located outside with respect to the base opening 22. The rib 10 surrounds the base opening 22 discontinuously with the discontinuous portions serving as the side holes 15. The rib 10 is patterned to take the shape of a circle, a polygon or the like with the height being equal to the thickness of the air gap 14.

The portion of the space between the vibration film 16 and the fixed film 8 located outside with respect to the rib 10 is made of a sacrifice film 12. The material of the sacrifice film 12 may be phosphosilicate glass, borophosphosilicate glass and the like, for example.

The side holes 15 are provided as discontinuous portions of the rib 10 surrounding the air gap 14. In FIG. 1C, one side hole 15 and its surroundings are shown in enlarged cross section. The height (size vertical to the vibration film 16) of the side hole 15 is preferably equal to or less than that of the air gap 14 from the standpoint of the fabrication process. For example, the height may be 0.2 μm to 5 μm. The width of the side hole 15 is preferably 0.05 μm to 5 μm, more preferably 0.5 μm to 2 μm, as the size allowing water vapor to be trapped therein or pass therethrough.

Although each side hole 15 has a fixed width in FIG. 1A, the width of the side hole 15 may be wide in the portion closer to the air gap 14 and tapered toward the outside. In reverse, it may be narrow in the portion closer to the air gap 14 and widened toward the outside (illustrations of these cases are omitted). Which shape is suitable depends on the use environment of electronic equipment incorporating the electret condenser 1. For example, in the case that the electret condenser 1 is used as a microphone of a cellular phone, in which the atmospheric pressure frequently changes, a difference arises in atmospheric pressure, temperature and the like between the external air and the inside of the electronic equipment, possibly causing condensation. Also, high/low inversion in atmospheric pressure frequently occurs between the inside and outside of the electronic equipment. The shape of the side holes 15 may be adjusted bearing such use environment of electronic equipment in mind.

The electrode terminals 28 are provided at predetermined positions in the peripheral portion of the first electrode 6. These are made by forming electrode terminal openings 5 through the surface protection film 4 to allow connection with the first electrode 6 at the electrode terminal openings 5. Such electrode terminal openings 5 are preferably formed not to be positioned above the side holes 15.

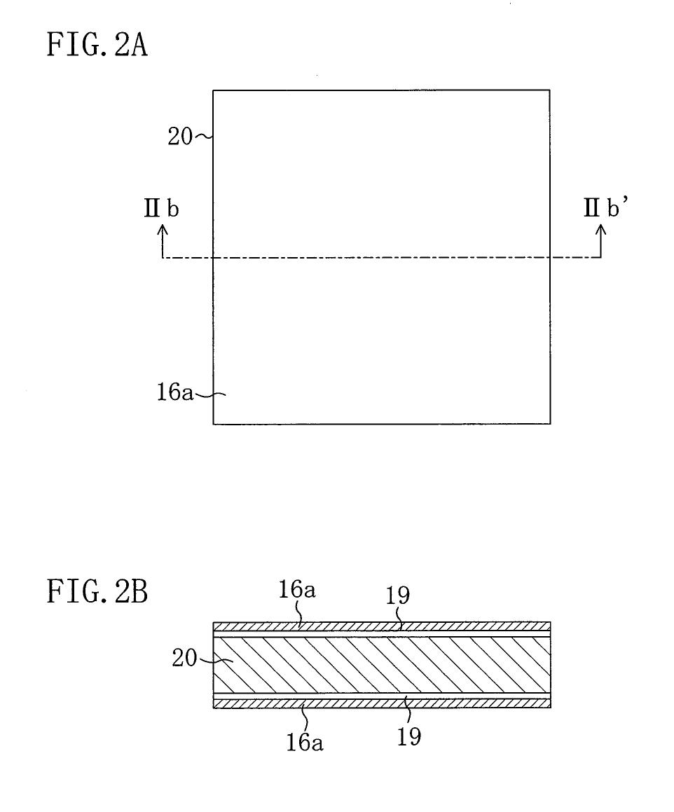

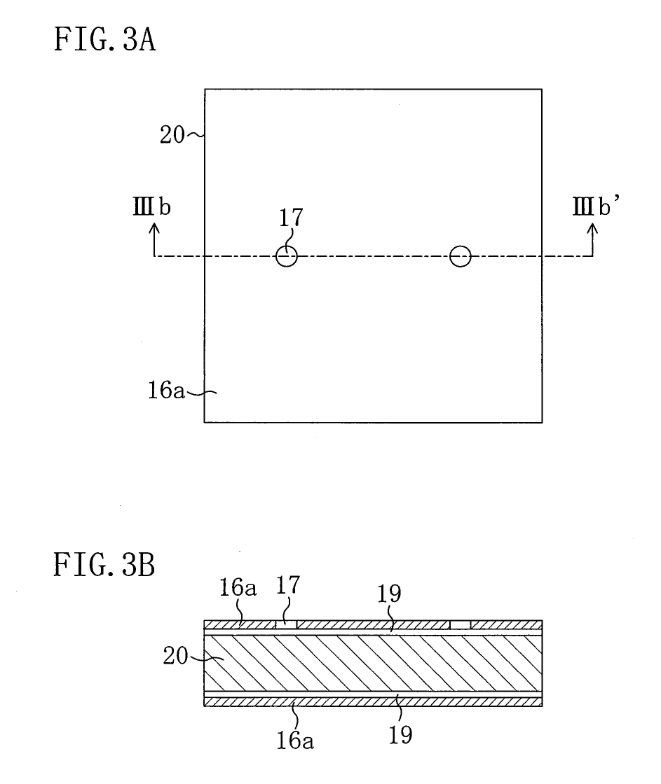

Next, the fabrication method for the electret condenser 1 of this embodiment will be described. FIGS. 2A and 2B show a fabrication process step for the electret condenser 1 in which FIG. 2A is a plan view and FIG. 2B is a cross-sectional view taken along line IIb-IIb′ in FIG. 2A. Likewise, FIGS. 3A and 3B through FIGS. 13A to 13B are respectively plan views and cross-sectional views showing respective fabrication process steps.

First, as shown in FIGS. 2A and 2B, silicon oxide films 19 and silicon nitride films 16a are formed one on another on both surfaces of a semiconductor substrate 20 made of silicon. More specifically, the silicon oxide films 19 are formed by dry or steam oxidation, and thereafter the silicon nitride films 16a are deposited to a predetermined thickness by decompression CVD with the film formation gas of SiH₂Cl₂ and NH₃. As another method, plasma CVD or sputtering may be used.

While the silicon nitride film 16a on the top surface of the semiconductor substrate 20 is to be worked into the vibration film 16 of the electret condenser 1 in a later process step, the silicon nitride film 16a on the bottom surface of the semiconductor substrate 20 is provided for protection of the bottom-side silicon oxide film 19 that is to be a mask for work on the semiconductor substrate 20. In other words, the latter is provided for preventing the bottom-side silicon oxide film 19 from decreasing in thickness and being damaged.

The process step shown in FIGS. 3A and 3B is then performed, in which FIG. 3A is a plan view and FIG. 3B is a cross-sectional view taken along line IIIb-IIIb′ in FIG. 3A.

In this process step, one or more second through holes 17 are formed through the silicon nitride film 16a on the top surface of the semiconductor substrate 20, which is to be the vibration film 16. Such second through holes 17 are formed in the portion that is to be the peripheral portion of the vibration film 16, by photolithography and reactive ion etching (RIE), for example. As the reactive gas used for RIE, C₂F₆ gas may be used, or any of CF₄, CF₄/O₂, CF₄/H₂, CHF₃/O₂, CHF₃/O₂/CO₂ and CH₂F₂/CF₄ may be used.

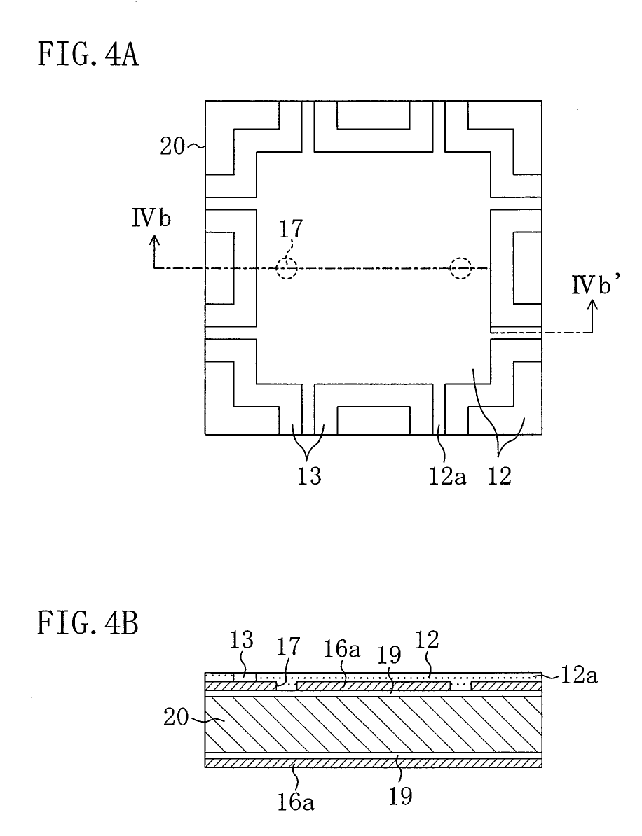

The process step shown in FIGS. 4A and 4B is then performed, in which FIG. 4A is a plan view and FIG. 4B is a cross-sectional view taken along line IVb-IVb′ in FIG. 4A.

A sacrifice film 12 is first formed over the top-side silicon nitride film 16a to bury the second through holes 17. For example, a layer of phosphosilicate glass is formed to a predetermined thickness by normal-pressure CVD with the film formation gas of PH₃/SiH₄/O₂. Plasma CVD may otherwise be used for film formation, and borophosphosilicate glass may otherwise be used as the material.

A rib formation groove 13 is then formed through the sacrifice film 12 in the portion thereof outside with respect to the portion in which the second through holes 17 were formed. The rib formation groove 13, which has a discontinuous pattern taking the shape of a circle or a polygon, is formed to a depth reaching the silicon nitride film 16a by photolithography and wet etching using a hydrogen fluoride (HF) etchant.

The sacrifice film 12 is left behind in regions 12a sandwiched between adjacent portions of the discontinuous rib formation groove 13. The regions 12a are to be the side holes 15 in a later process step, and the rib formation groove 13 is formed to leave the regions 12a behind as the shape necessary for this purpose.

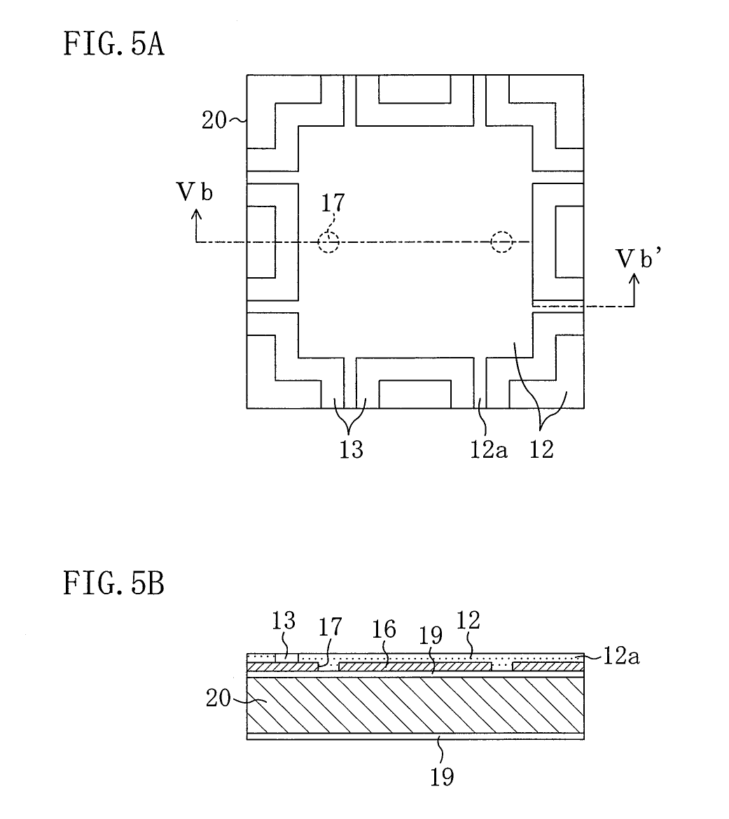

The process step shown in FIGS. 5A and 5B is then performed, in which FIG. 5A is a plan view and FIG. 5B is a cross-sectional view taken along line Vb-Vb′ in FIG. 5A. In this process step, the silicon nitride film 16a formed on the bottom surface of the semiconductor substrate 20 is removed. RIE may be adopted for this removal. As the reactive gas, C₂F₆ gas may be used, or any of CF₄, CF₄/O₂, CF₄/H₂, CHF₃/O₂, CHF₃/O₂/CO₂ and CH₂F₂/CF₄ may be used (these gases are the same as those used for RIE in the process step shown in FIGS. 3A and 3B). Note that the silicon nitride film 16a on the top surface of the semiconductor substrate 20 is left unremoved as the vibration film 16.

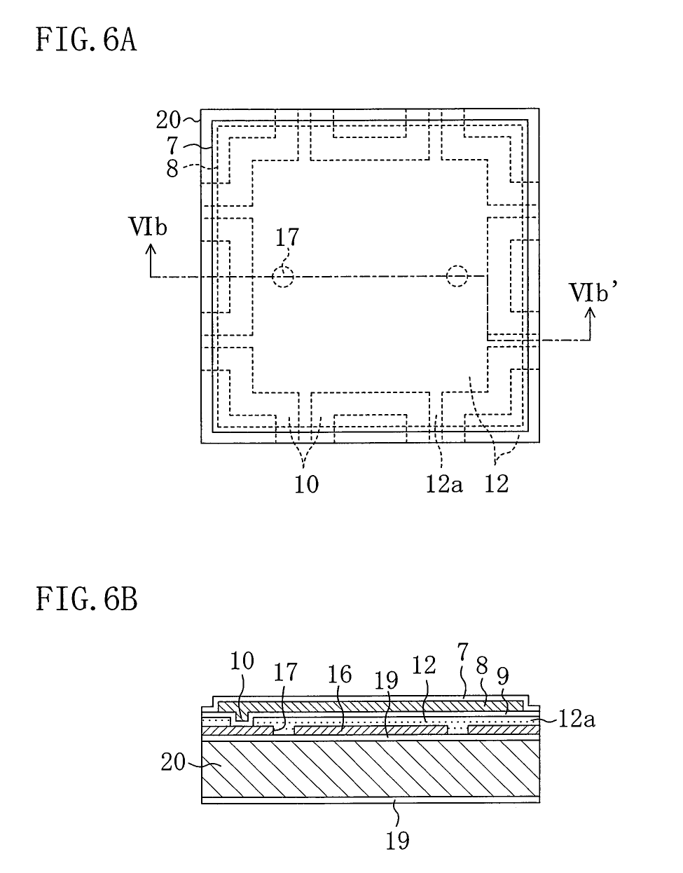

The process step shown in FIGS. 6A and 6B is then performed, in which FIG. 6A is a plan view and FIG. 6B is a cross-sectional view taken along line VIb-VIb′ in FIG. 6A. In this process step, a 3-layer film composed of the lower insulating film 9, the fixed film 8 and the upper insulating film 7 is formed on the sacrifice film 12. Note that part of the elements, such as the lower insulating film 9, is omitted in FIG. 6A.

First, the lower insulating film 9 made of a silicon nitride film and the fixed film 8 made of a silicon oxide film are sequentially formed on the sacrifice film 12 covering the rib formation groove 13 to respective predetermined thicknesses. The peripheral portion of the fixed film 8 is then removed by photolithography and RIE so that the external edges of the fixed film 8 are located inside with respect to the external edges of the lower insulating film 9. The upper insulating film 7 is then formed to cover the fixed film 8 and the exposed portion of the lower insulating film 9. The upper insulating film 7 is made of a silicon nitride film having a predetermined thickness.

Hence, a multilayer structure is obtained in which the sacrifice film 12 is sandwiched between the fixed film 8 and the vibration film 16 and is surrounded with the rib 10. Since the rib formation groove 13 is of a discontinuous shape, the rib 10 is also of a discontinuous shape having gaps, which gaps are the regions 12a described above having the sacrifice film 12 left unremoved.

Note that the upper insulating film 7 and the lower insulating film 9 are provided for preventing the fixed film 8 from decreasing in thickness and being damaged during working.

The lower insulating film 9 and the upper insulating film 7 are formed by plasma CVD with SiH₄/NH₃ as the film formation gas. The fixed film 8 may be formed by plasma CVD with Si(OC₂H₅)₄/O₂ as the film formation gas. As the reactive gas used for RIE during removal of the peripheral portion of the fixed film 8, CF₄ gas may be used, or any of C₄F₈/O₂/Ar, C₅F₈/O₂/Ar, C₃F₆/O₂/Ar, C₄F₈/Co, CHF₃/O₂ and CF₄/H may be used.

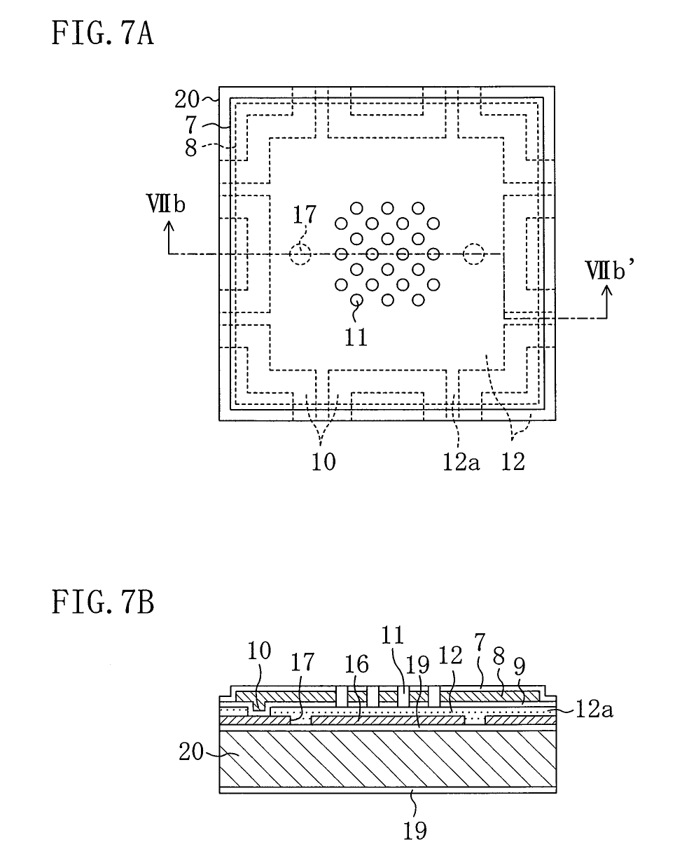

The process step shown in FIGS. 7A and 7B is then performed, in which FIG. 7A is a plan view and FIG. 7B is a cross-sectional view taken along line VIIb-VIIb′ in FIG. 7A. In this process step, a plurality of first through holes 11 are formed through the multilayer film composed of the lower insulating film 9, the fixed film 8 and the upper insulating film 7 in the center portion of the multilayer film. In this formation, CF₄, for example, is used as the reactive gas used for RIE. Otherwise, CF₄/H₂ or CHF₃/O₂ may be used.

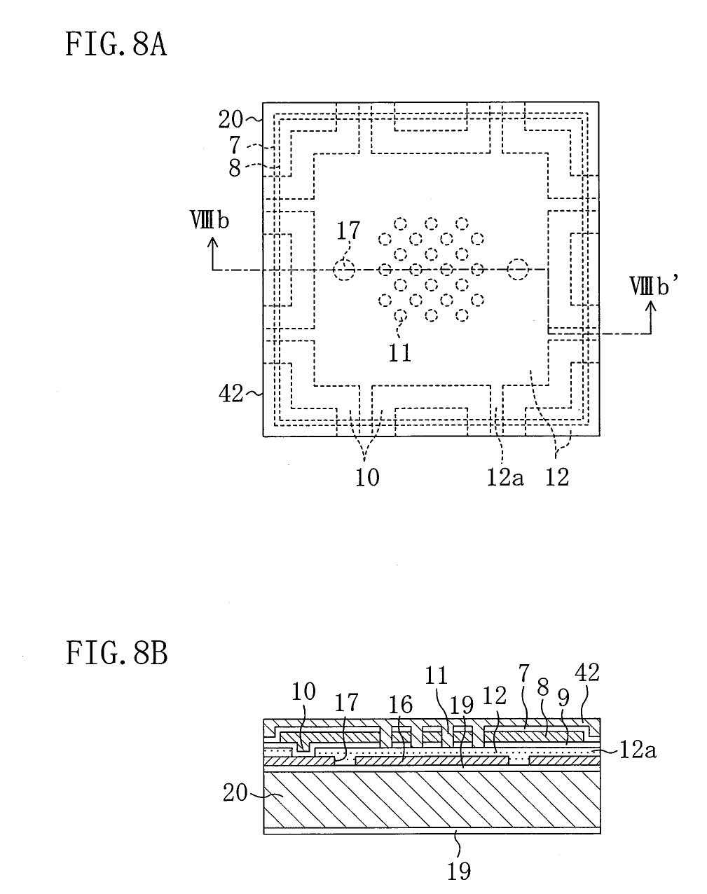

The process step shown in FIGS. 8A and 8B is then performed, in which FIG. 8A is a plan view and FIG. 8B is a cross-sectional view taken along line VIIIb-VIIIb′ in FIG. 8A. In this process step, a conductive film 42 is formed on the upper insulating film 7. In this formation, the first through holes 11 are also buried with the conductive film 42. The conductive film 42 can be formed by sputtering with an aluminum alloy as a material, for example. As another method, resistance heating evaporation may be adopted.

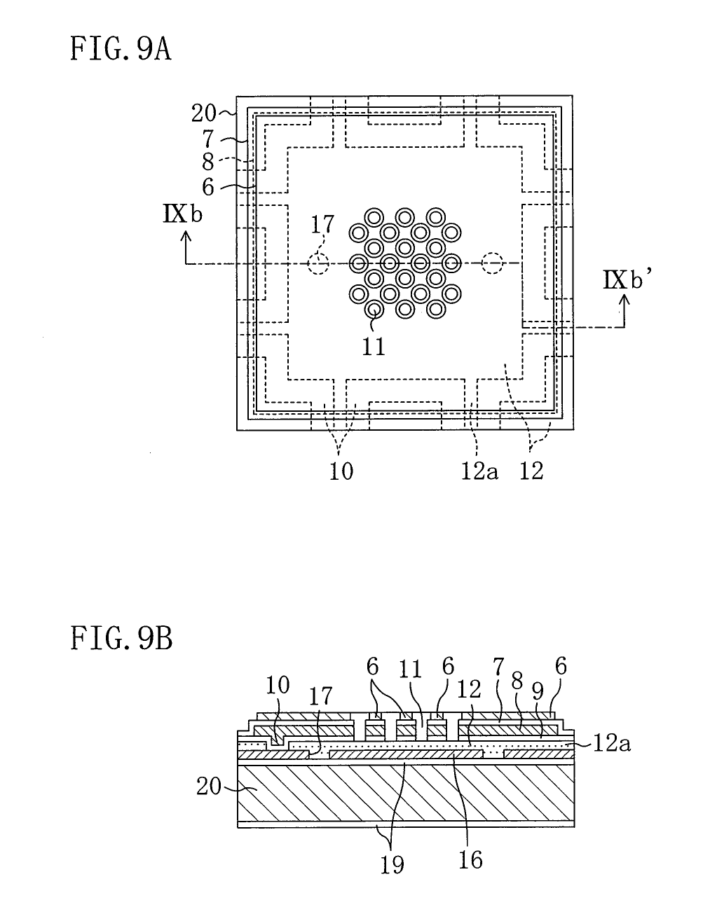

The process step shown in FIGS. 9A and 9B is then performed, in which FIG. 9A is a plan view and FIG. 9B is a cross-sectional view taken along line IVb-IVb′ in FIG. 9A. In this process step, the conductive film 42 is patterned to form the first electrode 6.

More specifically, portions of the conductive film 42 on the upper insulating film 7 corresponding to the surroundings of the first through holes 11, as well as the peripheral portion of the conductive film 42, are removed by photolithography and RIE, to have the pattern of the first electrode 6 that has the external edges located inside with respect to the external edges of the upper insulating film 7 and has a plurality of openings. As the reactive gas used for RIE, BCl₃/Cl₂ gas may be used, or any of BCl₃/CHF₃/Cl₂, BCl₃/CH₂/Cl₂, B/Br₃/Cl₂, BCl₃/Cl₂/N₂ and SiO₄/Cl₂ may be used.

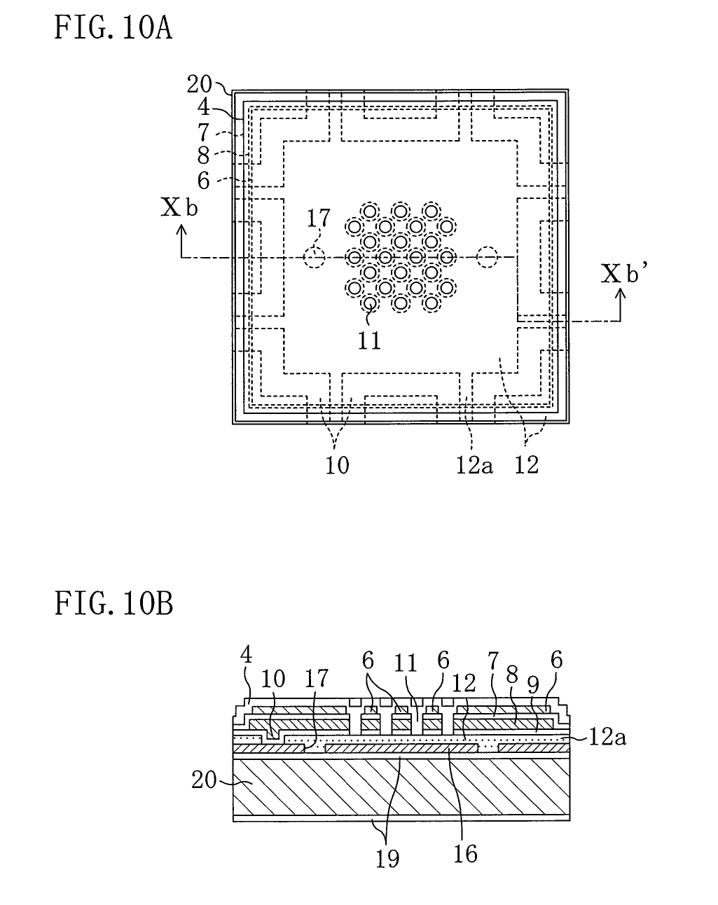

The process step shown in FIGS. 10A and 10B is then performed, in which FIG. 10A is a plan view and FIG. 10B is a cross-sectional view taken along line Xb-Xb′ in FIG. 10A. In this process step, the surface protection film 4 is formed to cover the first electrode 6. This may be formed as a silicon nitride film by plasma CVD using SiH₄/NH₃ as the film formation gas.

Normal-pressure CVD may be adopted as the film formation method. However, when the underlying first electrode 6 is made of an aluminum alloy, the resultant film will be less defective if the film formation temperature is 250° C. to 400° C. In view of this, plasma CVD is suitable.

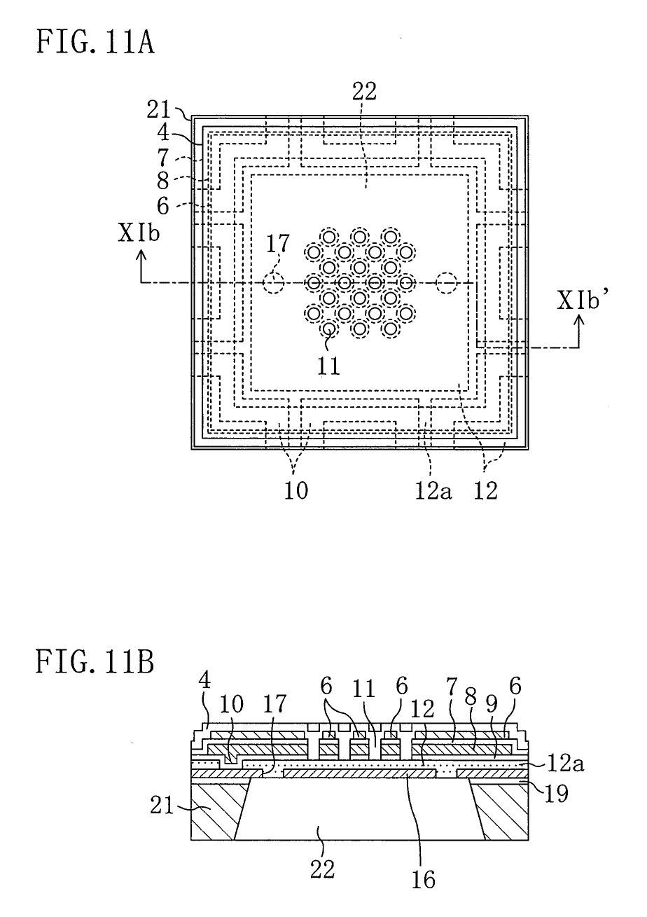

The process step shown in FIGS. 11A and 11B is then performed, in which FIG. 11A is a plan view and FIG. 11B is a cross-sectional view taken along line XIb-XIb′ in FIG. 11A. In this process step, the base opening 22 is formed in the semiconductor substrate 20 to form the base 21, to thereby provide a diaphragm composed of the base 21 and the vibration film 16.

First, the silicon oxide film 19 on the bottom surface of the semiconductor substrate 20 is subjected to photolithography and RIE to obtain an etching mask pattern for formation of the base opening 22. As the reactive gas used for RIE, CF₄ gas may be used, or any of C₄F₈/O₂/Ar, C₅F₈/O₂/Ar, C₃F₆/O₂/Ar, C₄F₈/Co, CHF₃/O₂ and CF₄/H may be used. In place of RIE, wet etching using an HF etchant may be adopted.

After formation of the etching mask pattern from the silicon oxide film 19, the semiconductor substrate 20 is wet-etched with a KOH liquid from the bottom surface thereof, to thereby form the base opening 22 extending through the semiconductor substrate 20. A NaOH liquid may be used as an etchant other than the KOH liquid.

Thereafter, the etching mask pattern on the back surface of the base 21 and the portion of the silicon oxide film 19 formed under the vibration film 16 in the base opening 22 are removed by immersing the resultant structure in an HF etchant. Note that the silicon oxide film 19 may be removed simultaneously with the formation of the base opening 22 by RIE. Hence, the diaphragm including the base 21 and the vibration film 16 is formed.

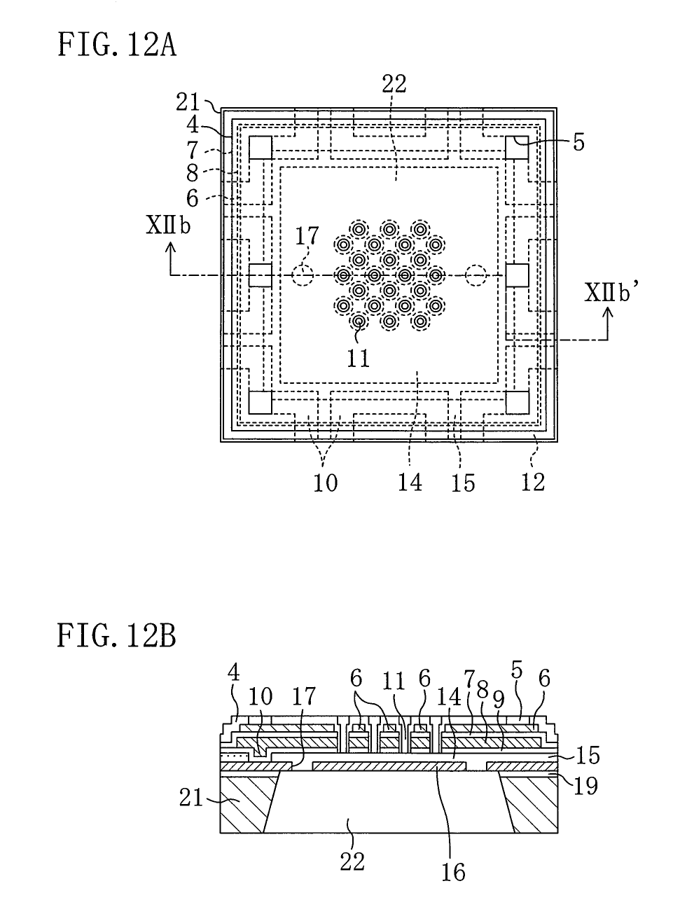

The process step shown in FIGS. 12A and 12B is then performed, in which FIG. 2512A is a plan view and FIG. 12B is a cross-sectional view taken along line XIIb-XIIb′ in FIG. 12A. In this process step, the first through holes 11 are formed through the surface protection film 4, and thereafter the air gap 14 and the side holes 15 are formed.

First, the portions of the surface protection film 4 filling the holes extending through the lower insulating film 9, the fixed film 8, the upper insulating film 7 and the first electrode 6 are removed to form the first through holes 11 reaching the sacrifice film 12. Simultaneously, predetermined positions of the surface protection film 4 on the first electrode 6 are removed to form the electrode terminal openings 5 for providing the electrode terminals 28. For the above removal, photolithography and RIE may be used. As the reactive gas used for RIE, C₂F₆ gas may be used, or any of CF₄, CF₄/O₂, CF₄/H₂, CHF₃/O₂, CHF₃/O₂/CO₂ and CH₂F₂/CF₄ may be used

The resultant structure is immersed in a B-HF (buffered hydrogen fluoride) etchant or any other HF etchant, and during the immersion, ultrasonic vibration is applied to the etchant to fluctuate the liquid, to thereby allow the etchant to flow into the first through holes 11 extending through the fixed film 8 and the like and the second through holes 17 extending through the vibration film 16. In this way, the portion of the sacrifice film 12 between the fixed film 8 and the vibration film 16 is removed forming the air gap 14. The portions of the sacrifice film 12 as the regions 12a extending through the rib 10 are also removed forming the side holes 15 extending from the air gap 14 through the rib 10 to outside.

With the fluctuation of the etchant under the ultrasonic vibration, the etchant is allowed to sufficiently circulate through the portions that are to be the air gap 14 and the side holes 15. Hence, variations in etching rate can be reduced. The circulation of the etchant can also be improved by raising the temperature to reduce the viscosity of the etchant. These ways can be adopted in combination.

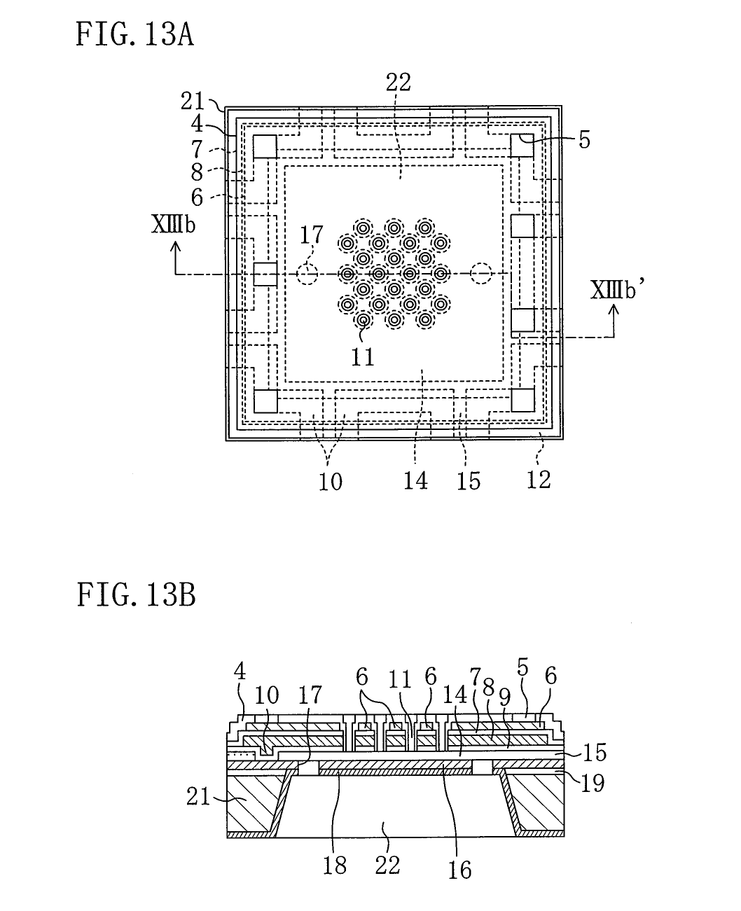

The process step shown in FIGS. 13A and 13B is then performed, in which FIG. 13A is a plan view and FIG. 13B is a cross-sectional view taken along line XIIIb-XIIIb′ in FIG. 13A. In this process step, the fixed film 8 is charged, and thereafter the second electrode 18 is formed.

The fixed film 8 made of a silicon oxide film is charged to accumulate charge by being exposed to corona discharge or plasma discharge. With this, the fixed film 8 is provided with the function as the electret film. Thereafter, a conductive film made of gold (Au) is formed on the back surface of the base 21, the sidewall of the base opening 22 and the bottom surface of the vibration film 16 by sputtering, to thereby form the second electrode 18. The conductive film may otherwise be formed by resistance heating. Hence, the structure of the electret condenser 1 is obtained.

Thereafter, a plurality of electret condensers 1 formed on the semiconductor substrate 20 are singularized by blade dicing, laser dicing, stealth dicing or the like.

In the manner described above, individual electret condensers 1 are fabricated. The electret condenser 1 obtained by the fabrication method described above, which can trap or remove moisture via the side holes 15 as already described, is excellent in moisture resistance, reliability, fabrication yield, performance and the like and can be downsized.

### Embodiment 2

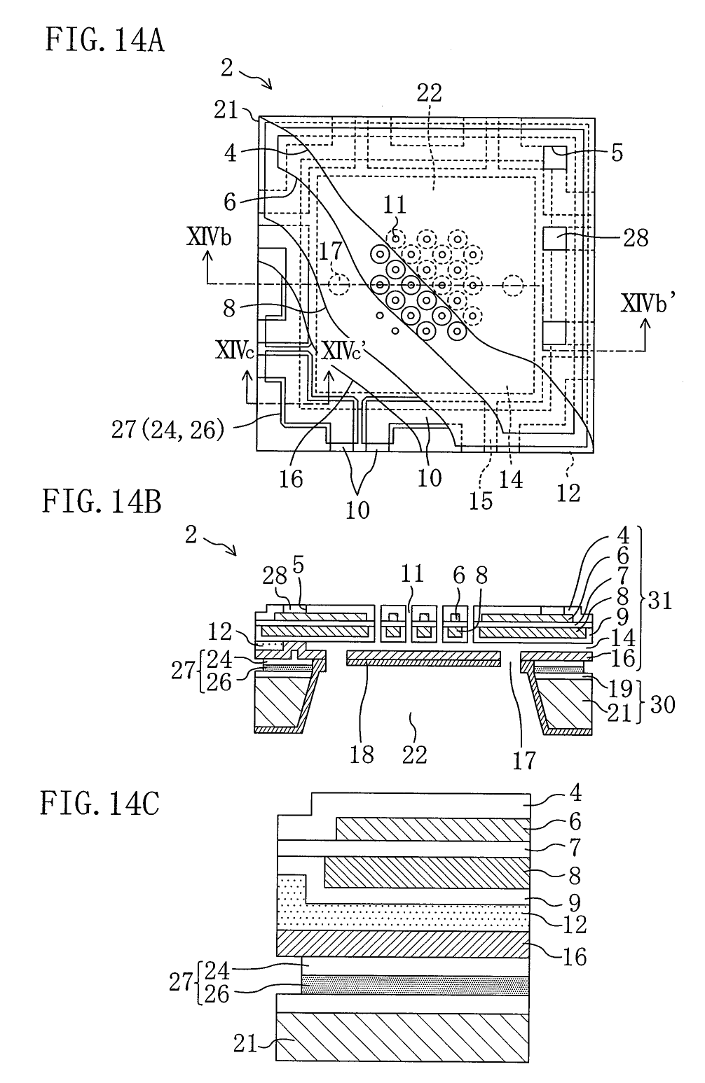

An electronic component of Embodiment 2 and a fabrication method for the same will be described. FIGS. 14A to 14C show a structure of an electret condenser 2 as an electronic component, in which FIG. 14A is a plan view with elements partly being cut away, FIG. 14B is a cross-sectional view taken along line XIVb-XIVb′ in FIG. 14A, and FIG. 14C is a cross-sectional view taken along line XIVc-XIVc′ in FIG. 14A.

The electret condenser 2 of this embodiment has a structure of a base part 30 and an electret condenser part 31 being bonded together with an alloy bonded layer 27.

The base part 30 includes a base 21 having a base opening 22 of a predetermined size provided in the center portion of a second semiconductor substrate 25 and a silicon oxide film 19 formed on the top surface of the base 21. Also, a second bonding film 26 is formed on the silicon oxide film 19. The second bonding film 26 has a discontinuous pattern that corresponds to the pattern of a first bonding film 24 formed on a vibration film 16 in the electret condenser part 31 to be described later.

The electret condenser part 31 includes an air gap 14 sandwiched between a fixed film 8 and the vibration film 16 and surrounded with a rib 10.

The rib 10, formed as a protrusion of the vibration film 16 toward the fixed film 8, surrounds the base opening 22 discontinuously with gaps that are to be side holes 15 left behind. The side holes 15 extend through the rib 10 from the air gap 14. The height of the rib 10 is about 0.5 μm to 10 μm, and thus the thickness of the air gap 14 (width of the space between the vibration film 16 and the fixed film 8) is also about 0.5 μm to 10 μm.

The top and bottom surfaces of the fixed film 8 are covered with an upper insulating film 7 and a lower insulating film 9, respectively. A first electrode 6 is provided on the fixed film 8 via the upper insulating film 7, and a surface protection film 4 is provided on the upper insulating film 7 to cover the first electrode 6. One or more first through holes 11 are provided to extend through all the lower insulating film 9, the fixed film 8, the upper insulating film 7, the first electrode 6 and the surface protection film 4, to reach the air gap 14. Note that the fixed film 8 and the first electrode 6 are not exposed to the inside of the holes, but the sidewalls of the holes are covered with the lower insulating film 9, the upper insulating film 7 and the surface protection film 4. The diameter of the through holes in the fixed film 8 is 3 μm to 10 μm.

Electrode terminal openings 5 are formed through the surface protection film 4 to reach the first electrode 6, and electrode terminals 28 are formed in the electrode terminal openings 5.

Second through holes 17 are formed through the vibration film 16. The first bonding film 24 is provided on the surface of the vibration film 16 opposite to the surface from which the rib 10 protrudes, so as to correspond to the second bonding film 26 in the base part 30.

The base part 30 and the electret condenser part 31 described above are bonded together once the second bonding film 26 and the first bonding film 24 provided in these parts are bonded together to become the alloy bonded layer 27, to thereby constitute the electret condenser 2 of this embodiment. A second electrode 18 is provided on the surface of the vibration film 16 facing the base part 30, the back surface of the base 21 (opposite to the surface facing the electret condenser part 31), and the sidewall of the base opening 22 of the base 21.

The electret condenser 2 of this embodiment is also provided with the side holes 15 as narrow tubes extending through the rib 10 from the air gap 14. Accordingly, like the electret condenser 1 of Embodiment 1, moisture having entered the air gap 14 or somehow existing therein can be trapped or discharged outside. Also, condensation in the air gap 14 can be suppressed. Hence, the electret condenser 2 of this embodiment is excellent in moisture resistance, reliability and performance, and also can be downsized.

With the structure of bonding the base part 30 and the electret condenser part 31 together, if a defect occurs in the base part 30 or the electret condenser part 31, replacement and reuse can be made.

The base 21, the vibration film 16, the air gap 14, the lower insulating film 9, the fixed film 8, the upper insulating film 7, the side holes 15, the electrode terminals 28 and the like are substantially the same as those in the electret condenser 1 of Embodiment 1, and thus detailed description on these members is omitted here.

In the alloy bonded layer 27, as described above, the second bonding film 26 provided on the base 21 is alloyed with the first bonding film 24 provided on the vibration film 16, to thereby bond the base part 30 and the electret condenser part 31 together. For example, the first and second bonding films 24 and 26 may be formed as a thin film pattern of gold and a thin film pattern of silicon, respectively. As other examples, combinations of gold and germanium, gold and tin, and gold and tin/lead eutectic solder may be used. Otherwise, tin/lead eutectic solder, tin/zinc eutectic solder and tin/bismuth eutectic solder may be used for both the first and second bonding films 24 and 26. Another combination of these may otherwise be used. In place of metal, a preimpregnated adhesive made of an organic material formed into a predetermined shape may be used for bonding.

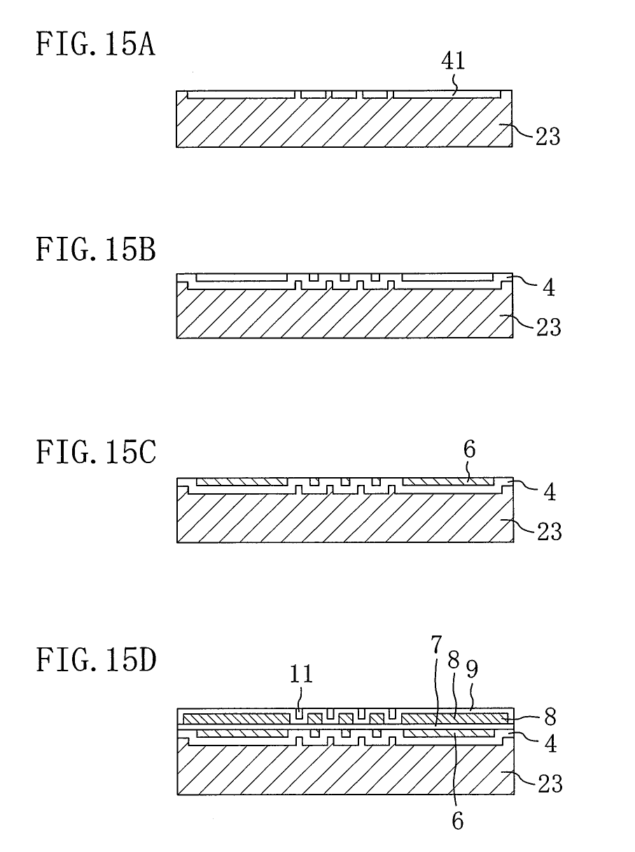

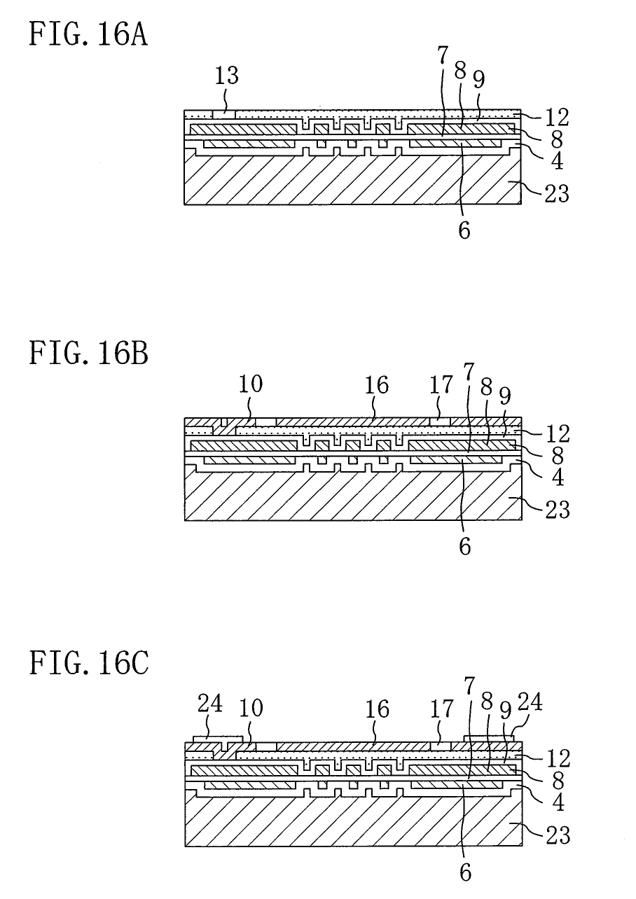

Next, a fabrication method for the electret condenser 2 of this embodiment will be described. As described above, the electret condenser part 31 and the base part 30 are formed separately and then bonded together. First, the fabrication process for the electret condenser part 31 will be described. FIGS. 15A to 15D and 16A to 16C are cross-sectional views illustrating the process steps for forming the electret condenser part 31.

The process step shown in FIG. 15A is first performed, in which a replica 41 for a multilayer film of the surface protection film 4 and the first electrode 6 of the electret condenser part 31 is formed on one surface of a first semiconductor substrate 23.

The replica 41 is a groove structure having a shape similar to the first electrode 6 patterned with a conductive film. The depth of the groove is equal to the thickness of the conductive film constituting the first electrode 6. The size of the groove along the plane of the first semiconductor substrate 23 is made larger than the size of the first electrode 6 by a value corresponding to the thickness of the surface protection film 4. More specifically, the size is preferably made larger by one to two times as large as the thickness of the surface protection film 4, more preferably by 1.2 to 1.6 times as large as the thickness of the surface protection film 4.

The replica 41 is formed by subjecting the first semiconductor substrate 23 to photolithography and RIE. As the reactive gas used for RIE, SF₆ gas may be used, or any of C₄F₈, CBᵣ/F₃, CF₄/O₂, Cl₂, SiCl₄/Cl₂, SF₆/N₂/Ar and BCl₂/Cl₂/Ar may be used.

The process step shown in FIG. 15B is then performed, in which the surface protection film 4 made of a silicon nitride film is formed covering the replica 41 on the first semiconductor substrate 23 to a predetermined thickness. The film formation of the surface protection film 4 is as described in the process step shown in FIGS. 10A and 10B in Embodiment 1.

The process step shown in FIG. 15C is then performed, in which the first electrode 6 is formed on the surface protection film 4. More specifically, a conductive film made of an aluminum alloy, for example, is deposited on the surface protection film 4 to the same thickness as the replica 4. Thereafter, portions of the conductive film that are to be the first through holes 11 and the portion thereof located above the periphery of the semiconductor substrate 23 are removed by photolithography and RIE, for example. The film formation and RIE of the conductive film are as described in the process steps shown in FIGS. 8A, 8B, 9A and 9B in Embodiment 1.

The process step shown in FIG. 15D is then performed, in which a 3-layer film composed of the upper insulating film 7, the fixed film 8 and the lower insulating film 9 is formed on the first electrode 6.

The upper insulating film 7 made of a silicon nitride film is first formed on the first electrode 6 made of a conductive film and the portions of the surface protection film 4 uncovered with the first electrode 6. The fixed film 8 made of a silicon oxide film is then formed on the upper insulating film 7 to a predetermined thickness. Thereafter, portions of the fixed film 8 corresponding to the first through holes 11 and the portion thereof located above the periphery of the semiconductor substrate 23 are removed by photolithography and RIE, for example. The lower insulating film 9 is then formed on the fixed film 8 and the exposed portions of the upper insulating film 7.

Note that the upper and lower insulating films 7 and 9 are named from their positions in the completed electret condenser 2. The film formation of the respective films, the RIE of the conductive film and the like are as described in the process steps shown in FIGS. 5A and 5B in Embodiment 1.

The process step shown in FIG. 16A is then performed, in which the sacrifice film 12 having the rib formation groove 13 is formed. The sacrifice film 12 made of phosphosilicate glass high in etching rate is deposited covering the entire surface of the lower insulating film 9. The thickness of the sacrifice film 12 is made equal to the height of the rib 10 that determines the thickness of the air gap 14 of the electret condenser 2. The rib formation groove 13 is then formed near the periphery of the sacrifice film 12 to reach the lower insulating film 9 by photolithography and RIE.

The rib formation groove 13 is formed so as to surround the portion of the sacrifice film 12 that is to be the air gap 14 discontinuously like the shape of the rib 10 shown in plan in FIG. 14A. The sacrifice film 12 is left behind in the regions 12a sandwiched between adjacent portions of the discontinuous rib formation groove 13, although in a later process step, the sacrifice film 12 is removed from the regions 12a to give the side holes 15.

The formation of the sacrifice film 12 and the rib formation groove 13 is as described in the process step shown in FIGS. 4A and 4B in Embodiment 1.

The process step shown in FIG. 16B is then performed, in which the vibration film 16 having the second through holes 17 is formed. The vibration film 16 made of a silicon nitride film is first deposited on the sacrifice film 12 to a predetermined thickness. During this deposition, the rib 10 is also formed from the silicon nitride film deposited in the rib formation groove 13, although the regions 12a extending through the rib 10 to outside remains as portions of the sacrifice film 12.

One or more second through holes 17 are then formed through the portion of the vibration film 16 surrounded with the rib formation groove 13 by photolithography and RIE. The film formation and RIE of the vibration film 16 are as described in the process steps shown in FIGS. 2A, 2B, 3A and 3B in Embodiment 1.

The process step shown in FIG. 16C is then performed, in which the first bonding film 24 is formed on the vibration film 16. A silicon film is deposited over the entire surface of the vibration film 16 by sputtering, for example. The silicon film is then patterned by photolithography and RIE, to form the first bonding film 24 to correspond to the rib 10 and its surroundings. As the reactive gas used for RIE, SF₆ gas may be used, or any of C₄F₈, CBᵣ/F₃, CF₄/O₂, Cl₂, SiCl₄/Cl₂, SF₆/N₂/Ar and BCl₂/Cl₂/Ar may be used.

Note that for the formation of the first bonding film 24, CVD using SiH₄ as the film formation gas may be adopted in place of sputtering to form the silicon film. Also, the pattering of the silicon film may be made by wet etching in place of RIE.

The process for forming the electret condenser part 31 using the first semiconductor substrate 23 is thus completed.

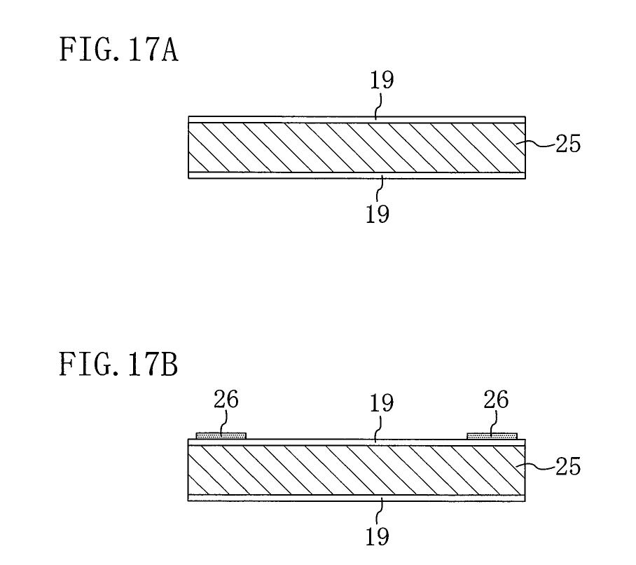

Next, the process for forming the base part 30 will be described. FIGS. 17A and 17B are views illustrating the process steps for forming the base part 30.

First, as shown in FIG. 17A, the silicon oxide films 19 are formed on both surfaces of the second semiconductor substrate 25. A specific way of this formation is as described in the process step shown in FIGS. 5A and 5B in Embodiment 1.

Thereafter, as shown in FIG. 17B, the second bonding film 26 is formed. More specifically, gold is deposited on the silicon oxide film 19 on one surface of the second semiconductor substrate 25 to a predetermined thickness by sputtering, and the resultant film is patterned by photolithography and RIE so as to correspond to the pattern of the first bonding film 24 formed in the electret condenser part 31. An iodine-group gas is used as the reactive gas for RIE.

For formation of the gold film, resistance evaporation may be adopted in place of sputtering. Otherwise, electroplating or electroless plating may be adopted. Also, for patterning of the gold film, wet etching using an iodine-group etchant may be adopted in place of RIE.

The process for forming the base part 30 using the second semiconductor substrate 25 is thus completed.

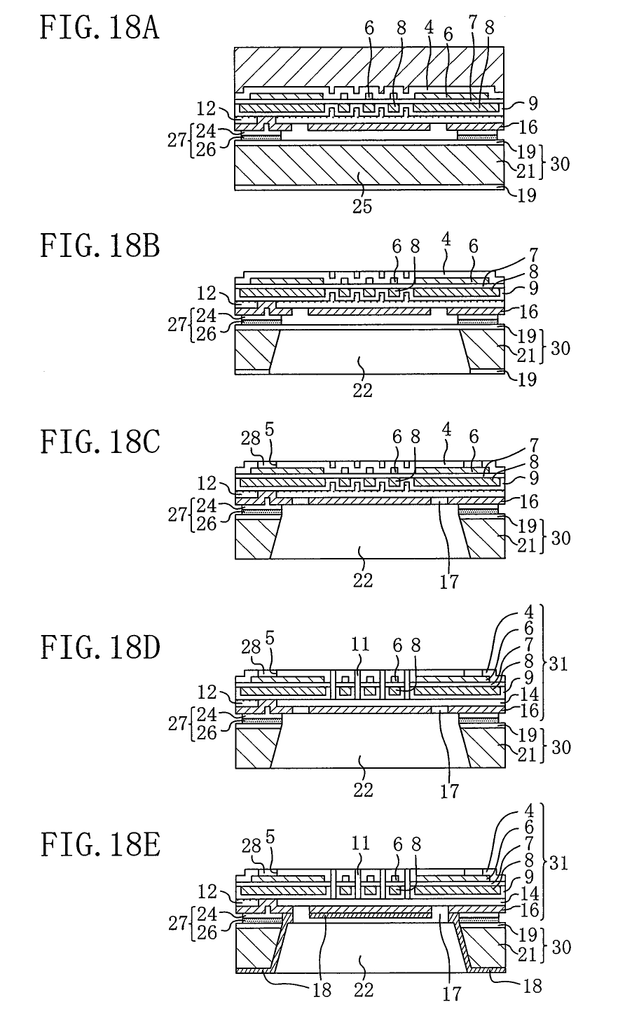

Next, the process for bonding together the structure on the first semiconductor substrate 23 and the structure on the second semiconductor substrate 25 formed separately, to complete the electret condenser 2 will be described. FIGS. 18A to 18E are cross-sectional views illustrating the process steps for this bonding.

First, as shown in FIG. 18A, with the second bonding film 26 formed on the second semiconductor substrate 25 and the first bonding film 24 formed on the first semiconductor substrate 23 being placed to face each other and aligned with each other, the first and second semiconductor substrates 23 and 25 are held and fixed to each other. Thereafter, while being heated to a temperature in the range of 400° C. to 500° C., at least one of the first and second semiconductor substrates 23 and 25 is subjected to ultrasonic vibration. This permits the first bonding film 24 and the second bonding film 26 to be gold-silicon alloyed/bonded to thereby form the alloy bonded layer 27. The temperature is then gradually reduced to room temperature, to allow bonding between the structure on the first semiconductor substrate 23 and the structure on the second semiconductor substrate 25.

The process step shown in FIG. 18B is then performed, in which the base opening 22 is formed in the second semiconductor substrate 25, and the first semiconductor substrate 23 is removed.

More specifically, an etching mask pattern (not shown) for formation of the base opening 22 is formed on the silicon oxide film 19 on the back surface of the second semiconductor substrate 25 by photolithography and RIE. Thereafter, by wet etching using a KOH liquid as an etchant, the base opening 22 reaching the silicon oxide film 19 on the top surface (closer to the first semiconductor substrate 23) of the second semiconductor substrate 25 is formed, and simultaneously the first semiconductor substrate 23 is entirely removed to expose the surface protection film 4. The etchant and the RIE are as described in the process step shown in FIGS. 11A and 11B in Embodiment 1.

The process step shown in FIG. 18C is then performed, in which the base 21 is formed.

More specifically, the mask pattern for formation of the base opening 22, the portion of the silicon oxide film 19 remaining in the base opening 22 of the second semiconductor substrate 25 and the portion of the silicon oxide film 19 remaining on the back surface of the second semiconductor substrate 25 surrounding the base opening 22 are removed. This removal may be made by immersion in an HF etchant or by RIE. A more detailed way of removal is as described in the process step shown in FIGS. 11A and 11B in Embodiment 1.

The process step shown in FIG. 18D is then performed, in which the air gap 14 and the side holes 15 are mainly formed.

The first through holes 11 are first formed extending through the lower insulating film 9, the upper insulating film 7 and the surface protection film 4 to reach the sacrifice film 12 by photolithography and RIE, as holes smaller than the holes formed through the fixed film 8 made of the silicon oxide film. Also, the electrode terminal openings 5 for formation of the electrode terminals 28 are formed by removing predetermined portions of the surface protection film 4 so as to expose the first electrode 6.

Thereafter, the resultant structure is immersed in a B-HF (buffered HF) or any other HF etchant, and during immersion, ultrasonic vibration is applied to the etchant to fluctuate the liquid, to thereby allow the etchant to flow into the first through holes 11 extending through the fixed film 8 and the like and the second through holes 17 extending through the vibration film 16. In this way, the portion of the sacrifice film 12 between the fixed film 8 and the vibration film 16 is removed forming the air gap 14. Also, the portions of the sacrifice film 12 as the regions 12a extending through the rib 10 are also removed forming the side holes 15 extending through the rib 10 from the air gap 14 to outside.

With the fluctuation of the etchant under the ultrasonic vibration, the etchant is allowed to sufficiently circulate through the portions that are to be the air gap 14 and the side holes 15. Hence, variations in etching rate can be reduced. The circulation of the etchant can also be improved by raising the temperature to reduce the viscosity of the etchant. These ways can be adopted in combination.

The RIE for formation of the first through holes 11 and the electrode terminal openings 5 extending through the surface protection film 4 is as described in the process step shown in FIGS. 12A and 12B in Embodiment 1.

The process step shown in FIG. 18E is then performed, in which the fixed film 8 is turned to the electret film and also the second electrode 18 is formed.

First, the structure shown in FIG. 18D is subjected to corona discharge or plasma discharge, to charge the fixed film 8 made of a silicon oxide film to allow charge accumulation. The fixed film 8 thus serves as the electret film. Thereafter, a conductive film made of gold (Au) is formed on the back surface of the base 21, the sidewall of the base opening 22 and the bottom surface of the vibration film 16 by sputtering, to thereby form the second electrode 18. The conductive film may otherwise be formed by resistance heating. Hence, the structure of the electret condenser 1 is obtained.

Thereafter, a plurality of electret condensers 1 formed on the semiconductor substrate 20 are singularized by blade dicing, laser dicing, stealth dicing or the like.

In the manner described above, the electret condenser 2 of this embodiment having the structure shown in FIGS. 14A to 14C can be fabricated. The electret condenser 2, which can trap or remove moisture via the side holes 15 as already described, is excellent in moisture resistance, reliability, fabrication yield, performance and the like and can be downsized.

Also, with the fabrication method in which the base part 30 and the electret condenser part 31 are individually formed and then bonded together, if a defect occurs in one of the parts, replacement and reuse can be easily done.

### Embodiment 3

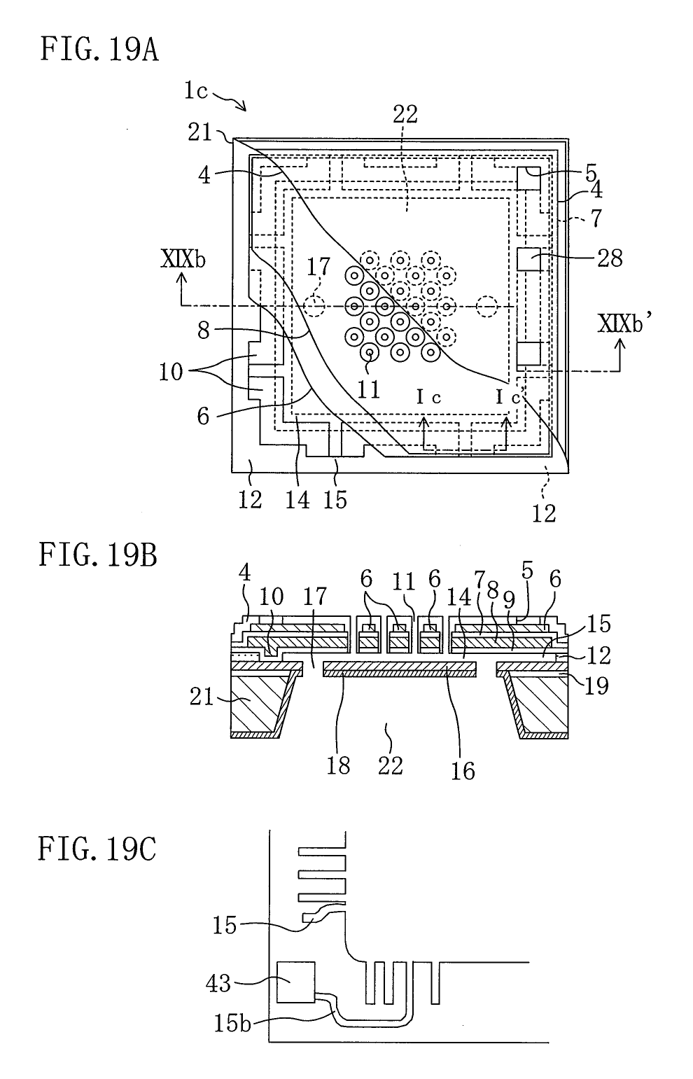

An electret condenser of Embodiment 3 of the present invention will be described. FIG. 19A is a plan view of an electret condenser 1c of this embodiment, and FIG. 19B is a cross-sectional view taken along line XIXb-XIXb′ in FIG. 19A.

The electret condenser 1c is the same in structure as the electret condenser 1 of Embodiment 1 except that side holes 15a do not extend through to outside. In FIGS. 19A to 19C, therefore, like elements are denoted by the same reference numerals as those in FIGS. 1A to 1C, and detailed description thereof is omitted. Hereinafter, the different point will be described.

In the electric condenser 1 of Embodiment 1, the side holes 15 sandwiched between adjacent portions of the rib 10 extend through the rib 10 as shown in FIG. 1A, for example. In other words, the air gap 14 communicates with the outside of the electret condenser 1. Hence, moisture can be discharged from the air gap 14 outside and dry air can be taken in from outside into the air gap 14.

In the electret condenser 1c of this embodiment, however, in which the rib 10 does not reach the periphery of the electret condenser 1c and thus the side holes 15a sandwiched between portions of the rib 10 do not extend through to outside, either. The ends of the side holes 15a extending from the air gap 14 outward in the rib 10 are blocked with the portion of the sacrifice film 12 remaining unremoved.

Hence, moisture in the air gap 14 are not discharged outside via the side holes 15a, but instead can be trapped (absorbed) into the side holes 15a. The side holes 15, which are narrow holes (capillaries), exert their capillary function to trap moisture. This can suppress sticking between the vibration film 16 and the fixed film 8 and decrease in surface resistance in the insulating section, to thereby suppress the occurrence of the component becoming unusable due to moisture and noise increase.

FIG. 19C shows the case that the side holes 15a extending from the air gap 14 are curved. Also shown is a moisture storing section 43 with a widened area. The moisture storing section 43 preferably has a porous structure such as pumice, a honeycomb structure, a scaly structure and the like to further increase its surface area for easy trapping of moisture.

### Embodiment 4

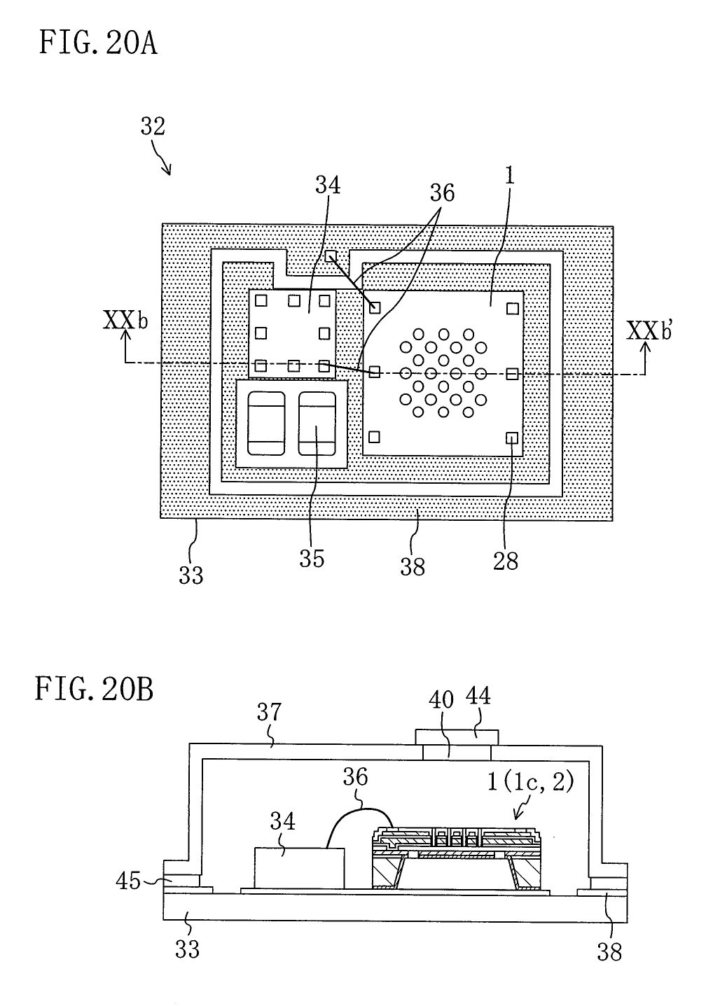

An ECM provided with a shield case of Embodiment 4 of the present invention will be described. FIG. 20A is a plan view of an ECM 32, and FIG. 20B is a cross-sectional view taken along line XXb-XXb′ in FIG. 20A.

The ECM 32 of this embodiment has a structure of the electret condenser 1 of Embodiment 1, a semiconductor element 34 and a passive electronic component 35 mounted on a printed circuit board 33 and covered with a shield case 37.

The printed circuit board 33 has a conductive pattern including mount regions on which the semiconductor element 34, the passive electronic component 35 and the electret condenser 1 are respectively mounted, interconnects for electrically connecting the mount regions with each other, and a shield case bonding region 38 provided in the peripheral portion to surround the mount regions and the interconnects. The passive electronic component 35 is bonded to the corresponding mount region by solder reflowing. The semiconductor element 34 is bonded to the corresponding mount region with a thermosetting or thermoplastic, conductive or insulating resin adhesive. The electret condenser 1 is bonded to the corresponding mount region with a thermosetting or thermoplastic, conductive resin adhesive.

Metal fine wires 36 are provided for connection between the electrode terminals 28 of the electret condenser 1 and electrode terminals of the semiconductor element 34 and between the electrode terminals 28 of the electret condenser 1 and electrode terminals of the printed circuit board 33.

The junction of the shield case 37 made of metal or a metal-coated resin is bonded to the shield case bonding region 38 on the printed circuit board 33 by solder reflowing.

A sound hole 40 is provided on the top surface of the shield case 37 and is covered with a heat-resistant cloth 44.

The ECM 32 having the configuration described above can be small, lightweight and excellent in characteristics.

The printed circuit board 33 is made of a glass epoxy resin, for example, or otherwise may be made of any one of alumina ceramic, polyimide, silicon and the like. The connection resistance between the shield case 37 and the printed circuit board 33 is set at 10 mΩ or less, preferably 5 mΩ or less.

Although the ECM 32 including the electret condenser 1 of Embodiment 1 was described in this embodiment, the ECM may naturally include the electret condenser 2 or 1c of Embodiment 2 or 3 in place of the electret condenser 1.

As described above, the electronic components of the above embodiments and the electronic devices using such electronic components can suppress occurrence of operation failure caused by moisture and noise increase, and thus are excellent in moisture resistance and performance and can be downsized. Hence, such electronic components and devices are useful in application to small, thin and lightweight acoustic equipment.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. An electronic component comprising:
a fixed film;
a vibration film facing the fixed film;
a first electrode provided on the fixed film, the first electrode having at least one first through hole;
a second electrode provided on a portion of the vibration film corresponding to the first electrode;
an air gap provided between the fixed film and the vibration film and surrounded with a rib, the air gap communicating with the first through hole and the second through hole; and
at least one side hole provided in the rib surrounding the air gap, the side hole communicating with the air gap.

2. The electronic component of claim 1, wherein the first through hole is provided in the center portion of the first electrode, and
the second through hole is provided in the peripheral portion of the second electrode.

3. The electronic component of claim 1, wherein the at least one side hole extends through the rib.

4. The electronic component of claim 1, wherein the at least one side hole has a curved shape.

5. The electronic component of claim 1, wherein the thickness of the at least one side hole is the same as the thickness of the air gap.

6. The electronic component of claim 1, further comprising a base made of a substrate having an opening,
wherein a first bonding metal film provided on a portion of the vibration film and a second bonding metal film provided on the base are connected to each other.

7. The electronic component of claim 1, wherein the electronic component is a sensor switch or an electret condenser microphone.

8. A fabrication method for an electronic component, comprising the steps of:
forming a multilayer structure including a structure having a sacrifice film sandwiched between a fixed film and a vibration film and surrounded with a rib; and
forming an air gap sandwiched between the fixed film and the vibration film and surrounded with the rib by removing the sacrifice film from the multilayer structure,
wherein in the step of forming a multilayer structure, part of the sacrifice film is made to extend in the rib, and in the step of forming an air gap, at least one side hole extending in the rib from the air gap is provided in addition to the air gap.

9. The fabrication method of claim 8, wherein the step of forming a multilayer structure comprises the steps of:
(a) forming a vibration film having at least one vibration film through hole on a semiconductor substrate;
(b) forming a sacrifice film on the vibration film, the sacrifice film having a rib formation groove surrounding a region in which the vibration film through hole is formed and having a depth reaching the vibration film;
(c) forming a fixed film having at least one fixed film through hole on the sacrifice film and also forming a rib in the rib formation groove;
(d) forming a first electrode made of a conductive film on a portion of the fixed film excluding the fixed film through hole and its surroundings and then forming a surface protection film covering the first electrode; and
(e) after the step (d), forming a base by forming an opening in the center portion of the semiconductor substrate to reach the back surface of the vibration film,
after the step (e), the step of forming an air gap is performed,
after the step of forming an air gap, the fabrication method further comprises the step of forming a second electrode made of a conductive film at least on the surface of the vibration film facing the base, and
in the step (b), the sacrifice film is formed so that part of the sacrifice film surrounded with the rib formation groove extends in the rib formation groove, and thus in the step (c), part of the sacrifice film surrounded with the rib extends in the rib.

10. The fabrication method of claim 9, wherein the second electrode is formed on the sidewall of the opening of the base and the bottom surface of the base, in addition to the surface of the vibration film facing the base.

11. The fabrication method of claim 9, wherein the step of forming an air gap is performed using wet etching, and
an etchant used for the wet etching is heated to reduce the viscosity.

12. The fabrication method of claim 11, wherein ultrasonic vibration is applied to the etchant.

13. The fabrication method of claim 8, wherein the step of forming a multilayer structure comprises the steps of:
(f) forming a surface protection film on one surface of a first semiconductor substrate and then forming a first electrode made of a conductive film on the surface protection film:
(g) forming a fixed film having at least one fixed film through hole on the surface protection film so as to cover the first electrode;
(h) forming a sacrifice film on the fixed film, the sacrifice film having a rib formation groove surrounding a region in which the fixed film through hole is formed and having a depth reaching the fixed film;
(i) forming a vibration film having at least one vibration film through hole on the sacrifice film and also forming a rib in the rib formation groove;
(j) forming a first bonding metal film on a portion of the vibration film located above the rib;
(k) forming an oxide film on a second semiconductor substrate different from the first semiconductor substrate, and then forming a second bonding metal film on the oxide film so as to correspond to the first bonding metal film;
(l) aligning the first bonding metal film and the second bonding metal film with each other to face each other and alloying the bonding metal films with each other, to bond the first semiconductor substrate and the second semiconductor substrate to each other; and
(m) forming a base by forming an opening in the center portion of the second semiconductor substrate,
after the step (m), the step of forming an air gap is performed,
after the step of forming an air gap, the fabrication method further comprises the step of forming a second electrode made of a conductive film at least on the surface of the vibration film facing the base, and
in the step (h), the sacrifice film is formed so that part of the sacrifice film surrounded with the rib formation groove extends in the rib formation groove, and thus in the step (i), part of the sacrifice film surrounded with the rib extends in the rib.

14. The fabrication method of claim 13, wherein the second electrode is formed on the sidewall of the opening of the base and the bottom surface of the base, in addition to the surface of the vibration film facing the base.

15. The fabrication method of claim 13, wherein the step of forming an air gap is performed using wet etching, and
an etchant used in the wet etching is heated to reduce the viscosity.

16. The fabrication method of claim 17, wherein ultrasonic vibration is applied to the etchant.

17. An electronic device comprising:
the electronic component of claim 1;
at least one semiconductor element;
at least one passive electronic component;
a printed board having two mount regions, the electronic component, the semiconductor element and the passive electronic component being mounted on one of the mount region while external connection terminals being provided on the other mount region;
metal fine wires for connecting electrode terminals of the electronic component with electrode terminals of the printed board and electrode terminals of the semiconductor element; and
a shield case attached to the printed board to cover the electronic component, the semiconductor element, the passive electronic component and metal fine wires.
